(19) United States
(12) Patent Application Publication
(10) Pub. No.: US 2023/0237464 A1
(43) Pub. Date: Jul. 27, 2023

(54) System and Method for Providing Transaction Report Data Using A User Device

(71) Applicant: Mastercard International Incorporated, New York, NY (US)

(72) Inventors: James Christian Noë, West Wickham (GB); John Tierney, Merseyside (GB); Simon Phillips, York (GB); Ian David Alan Maddocks, Broughton (GB)

(21) Appl. No.: 17/580,403

(22) Filed: Jan. 20, 2022

(51) Int. Cl. G06Q 20/34; G06Q 20/40; G06Q 20/32

(52) U.S. Cl. CPC G06Q 20/341; G06Q 20/401; G06Q 20/3276

(57) ABSTRACT

Various implementations described herein may relate to a system and method for providing transaction report data using a user device. In one implementation, a method may include receiving, at a token service provider (TSP), tokenization request data from a user device associated with a user, where the tokenization request data includes payment card data associated with the user. The method may also include generating a digital token based on the tokenization request data. The method may further include transmitting the digital token to the user device. The method may additionally include receiving transaction report data from the user device, where the transaction report data corresponds to a failed payment transaction performed using the digital token, the user device, and a merchant system. The method may also include generating failure data based on the transaction report data, where the failure data comprises alert data, failure report data, or combinations thereof.

### BACKGROUND

This section is intended to provide background information to facilitate a better understanding of various technologies described herein. As the section’s title implies, this is a discussion of related art. That such art is related in no way implies that it is prior art. The related art may or may not be prior art. It should therefore be understood that the statements in this section are to be read in this light, and not as admissions of prior art.

Payment cards can be used to perform several types of financial transactions, including payment transactions. As is known in the art, the payment card may be a credit card, a debit card, a prepaid card, and/or the like. Further, the payment card may be associated with a payment account of a user. In particular, in order to perform a payment transaction between the user and a merchant, the payment card may be used to provide the merchant with data relating to the payment account of the user. In one scenario, to provide this data to the merchant, the user may swipe a magnetic stripe of a physical payment card through a magnetic stripe reader of a merchant point-of-sale (POS) device. In another scenario, to provide this data to the merchant, an integrated circuit (IC) of a physical payment card (i.e., a chip card, a smart card, and/or the like) may be used to communicate with a smart card reader of the merchant POS device. Such a payment card may communicate with the smart card reader via contact-based and/or contactless communication.

In some scenarios, the user may configure a computing device (e.g., a mobile device, a wearable device, and/or the like) to operate as a payment card in order to perform the payment transaction with the merchant, where the payment transaction may be an in-person transaction and/or an online transaction. In particular, data relating to the payment card of the user may be stored on the computing device via a wallet application, such that the computing device may be used to act as a proxy of a physical payment card or as a virtual payment card. In one scenario, the computing device may be configured to carry out an in-person payment transaction between the user and the merchant by communicating the stored data to the merchant POS device, such as through contactless communication.

### SUMMARY

Described herein are implementations of various technologies relating to a system and method for providing transaction report data using a user device. In one implementation, a method may include receiving, at a token service provider (TSP), tokenization request data from a user device associated with a user, where the tokenization request data includes payment card data associated with the user. The method may also include generating, at the TSP, a digital token based on the tokenization request data. The method may further include transmitting, using the TSP, the digital token to the user device. The method may additionally include receiving, at the TSP, transaction report data from the user device, where the transaction report data corresponds to a failed payment transaction performed using the digital token, the user device, and a merchant system. The method may also include generating, at the TSP, failure data based on the transaction report data, where the failure data comprises alert data, failure report data, or combinations thereof.

In another implementation, a method may include receiving, at a user device associated with a user, a digital token from a token service provider (TSP), where the digital token corresponds to payment card data associated with the user. The method may also include determining a failed payment transaction has occurred, where the failed payment transaction is performed using the digital token, the user device, and a merchant system. The method may further include generating, at the user device, transaction report data based on the determination. The method may additionally include transmitting, using the user device, the transaction report data to the TSP.

In yet another implementation, a system may include a user device associated with a user, where the user device includes one or more first processors. The user device may also include at least a first memory having a plurality of program instructions which, when executed by the one or more first processors, cause the one or more first processors to: receive a digital token from a token service provider (TSP), where the digital token corresponds to payment card data associated with the user; determine a failed payment transaction has occurred, where the failed payment transaction is performed using the digital token, the user device, and a merchant system; generate transaction report data based on the determination; and transmit the transaction report data to the TSP. The TSP may include one or more second processors. The TSP may also include at least a second memory having a plurality of program instructions which, when executed by the one or more second processors, cause the one or more second processors to: generate the digital token based on the payment card data; transmit the digital token to the user device; receive the transaction report data from the user device; and generate failure data based on the transaction report data, where the failure data comprises alert data, failure report data, or combinations thereof.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Implementations of various techniques will hereafter be described with reference to the accompanying drawings. It should be understood, however, that the accompanying drawings illustrate only the various implementations described herein and are not meant to limit the scope of various techniques described herein.

FIG. 1 illustrates a schematic diagram of a system in accordance with implementations of various techniques described herein.

FIGS. 2-5 illustrate a sequencing diagram in accordance with implementations of various techniques described herein.

FIG. 6 illustrates a diagram of a computing system in which one or more various technologies described herein may be incorporated and practiced.

### DETAILED DESCRIPTION

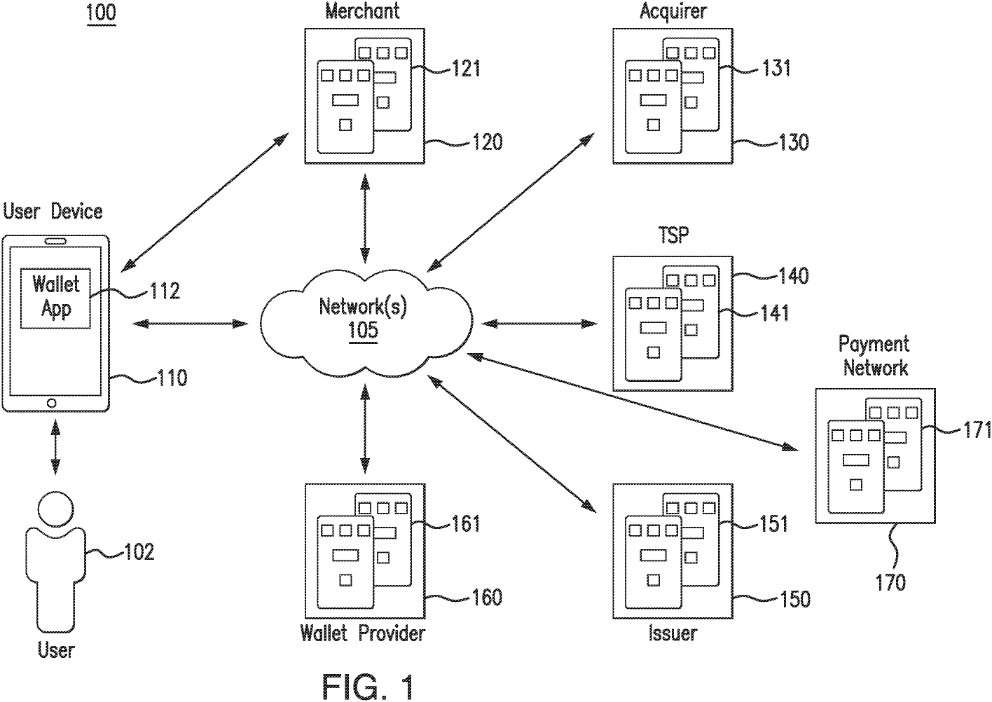

Various implementations directed to a system and method for providing transaction report data using a user device will now be described in the following paragraphs with reference to FIGS. 1-6.

As is known in the art, a user may utilize a payment account to fund various types of financial transactions, including a payment transaction with a merchant. The user may be any entity known to those skilled in the art, including, but not limited to, the following: an individual person, a family, a commercial entity, a company, a corporation, a governmental entity, a non-profit organization, and/or the like. The merchant may be an entity capable of providing one or more products for sale to the user. In particular, the merchant may be any entity known in the art, including, but not limited to, the following: an individual person, a family, a commercial entity, a company, a corporation, a governmental entity, a non-profit organization, and/or the like. The one or more products may include any good and/or service known to those skilled in the art. For example, the one or more products may include parts, material, merchandise, supplies, equipment, components, food, and/or the like.

The payment transaction may refer to a transaction by the user to purchase the one or more products from the merchant using funds from the payment account. As is known in the art, the payment transaction may be an in-person payment transaction and/or an online payment transaction between the user and the merchant. In addition, the payment account may be associated with the user (e.g., the user is the account holder) and may include any type of financial account known to those skilled in the art that can be used to fund the payment transaction. For example, the payment account may be a banking account, a checking account, a savings account, a credit card account, a debit card account, a prepaid card account, a virtual payment account, and/or the like.

In one scenario, the user may utilize a payment card in order to perform the payment transaction with the merchant. The payment card may be any type of card known in the art, including a physical card or a virtual card. Examples of the payment card may include, but are not limited to, the following: a debit card, a credit card, a prepaid card, a virtual payment card, virtual payment numbers, virtual card numbers, a foreign exchange card, a charge card, a stored-value card, and/or the like. As is known in the art, the payment card may be linked with the payment account of the user, such that the user can use the payment card to fund the payment transaction via the payment account. In particular, to perform the payment transaction using the payment card, the user may provide the merchant with data corresponding to the payment card. Such data may include data corresponding to a primary account number (PAN) for the payment card, an expiration date for the payment card, a Card Validation Code (CVC) for the payment card, and/or the like. This data corresponding to the payment card may hereinafter be referred to as payment card data.

In a further scenario, the user may utilize a computing device in order to perform the payment transaction using the payment card. The computing device may be associated with the user and may hereinafter be referred to as a user device. The user device may be any type of device known to those skilled in the art, including, but not limited to, a mobile device (e.g., a smartphone), a wearable device (e.g., a smartwatch), and/or the like. In such a scenario, the user may utilize a wallet application stored on the user device to perform the payment transaction with the merchant via the payment card. The wallet application can be any type of software application known to those skilled in the art, where the wallet application is configured to store, manage, and/or transmit data relating to a payment account. For example, the wallet application may include, but is not limited to, the following: a mobile banking application, a digital wallet application associated with a wallet provider, and/or the like.

In this scenario, prior to performing the payment transaction, the user may initially utilize the wallet application to store data linked to the payment card on the user device, such as by storing this data within the wallet application itself. As further described below, this data may include the payment card data of the payment card, a digital token corresponding to the payment card, and/or the like.

The user may then perform the payment transaction by utilizing the wallet application to transmit this data from the user device to a merchant system of the merchant, where the merchant system may include a merchant point-of-sale (POS) device, a merchant server, and/or the like. In one example, the user device and/or the wallet application may be configured to communicate with a merchant system to perform a chip-based payment transaction, such as with a merchant system having a smart card reader. In particular, the user device and/or the wallet application may process the chip-based payment transaction by emulating a physical payment card having an integrated circuit (e.g., a chip card, a smart card, and/or the like) during the transaction. In such an example, the user device and/or the wallet application may be configured to process the payment transaction and communicate with the merchant system in accordance with EMV-based standards, protocols, and/or specifications (e.g., specifications provided by EMVCo). In another example, the user device and/or the wallet application may be configured to communicate with a merchant system to perform a magnetic stripe-based payment transaction, such as with a merchant system having a magnetic stripe reader. In particular, the user device and/or the wallet application may process the magnetic stripe-based payment transaction by emulating a physical payment card having a magnetic stripe during the transaction. The user device may be configured to communicate with the merchant system using any technique known to those skilled in the art, including, but not limited to, contactless communication, near-field communication (NFC), wireless communication, cellular communication, and/or the like.

The merchant system may then further perform the payment transaction by transmitting the data among one or more other entities, such as an acquirer, a payment network, and an issuer. As is known in the art, the acquirer may be a financial institution that provides one or more services for the processing of payment card-based transactions for the merchant. In addition, the payment network may refer to a network and/or collection of systems used to facilitate payment transactions for the acquirer and the issuer. As is also known in the art, the issuer may be a financial institution (e.g., a bank, a credit card company, and/or the like) that maintains the payment account for the user and issues the payment card associated with the account to the user. For a successful payment transaction, the issuer may, based on the data, provide an authorization response indicating that the payment transaction is approved. In particular, after the issuer approves the payment transaction, the payment transaction may be funded via a transfer of funds between the payment account of the user and a financial account of the merchant.

In one example, the user may utilize the wallet application to perform an in-person payment transaction with the merchant using the payment card data stored on the user device, where the payment card data is an example of the above-mentioned data linked to the payment card. In particular, prior to performing the in-person payment transaction, the user may initially utilize the wallet application to store the payment card data of the payment card on the user device. As noted above, the payment card may be a physical card or a virtual card. The user may then perform the in-person payment transaction by using the wallet application to transmit the payment card data from the user device to a merchant POS device using NFC technology. The merchant may then further perform the payment transaction by transmitting the payment card data to the one or more other entities (e.g., the acquirer, the payment network, and/or the issuer), as described above. As noted above, for a successful payment transaction, the issuer may, based on the payment card data, provide an authorization response indicating that the payment transaction is approved.

In another example, the user may utilize the wallet application to perform an in-person payment transaction with the merchant using a digital token stored on the user device, where the digital token is an example of the above-mentioned data linked to the payment card. In particular, the digital token may correspond to the payment card, where the payment card may be a physical card and/or a virtual card. As is known in the art, the digital token may include tokenized data that corresponds to the payment card data of the payment card. For example, the digital token may include data corresponding to a unique alternate card number that can be used to replace a PAN (e.g., a 16-digit number) of the payment card in the payment transaction, where the alternate card number may be similar in structure to the PAN. The digital token may also include data that corresponds to an alternate expiration date and/or an alternate CVC that can be used to replace the expiration date and/or the CVC of the payment card in the payment transaction.

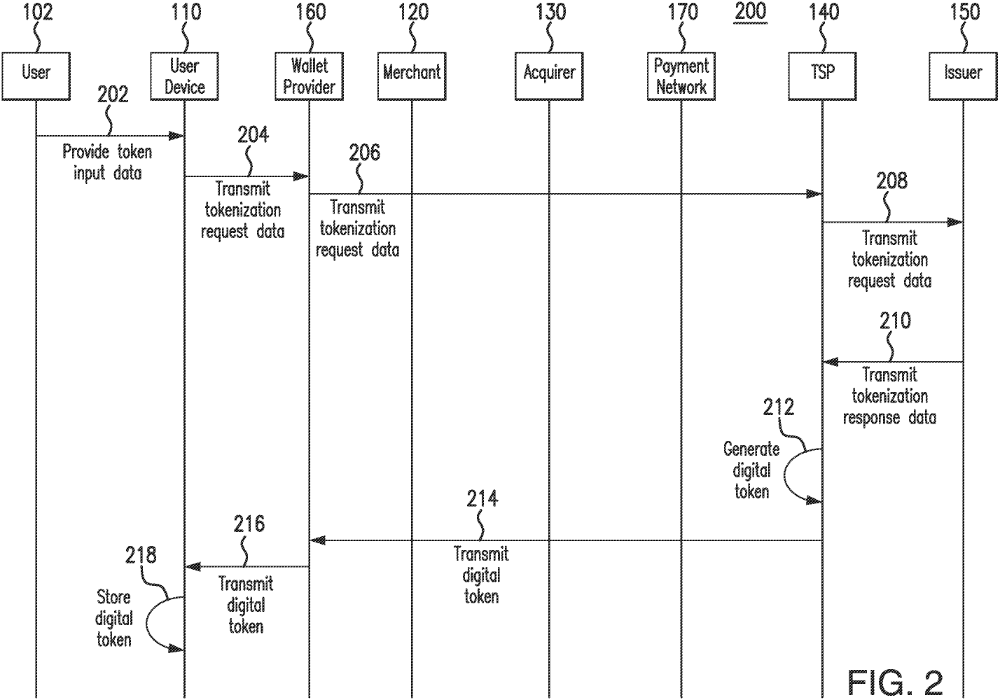

In such an example, prior to performing the in-person payment transaction, the user may initially utilize the wallet application to acquire and store the digital token on the user device. The digital token may be acquired and stored by the wallet application using any technique known in the art. In particular, during a tokenization process, a token service provider (TSP) may generate the digital token using the payment card data of the payment card. The wallet application may then receive and store the digital token from the TSP, such as by storing the digital token within the wallet application itself. As is known in the art, the TSP may be any entity that is responsible for issuing and managing digital tokens, including tokens configured for use in payment transactions. One or more implementations for performing the tokenization process are further described later with respect to FIG. 2. In some instances, the payment network may also operate as the TSP. In other instances, the payment network and the TSP may be separate entities.

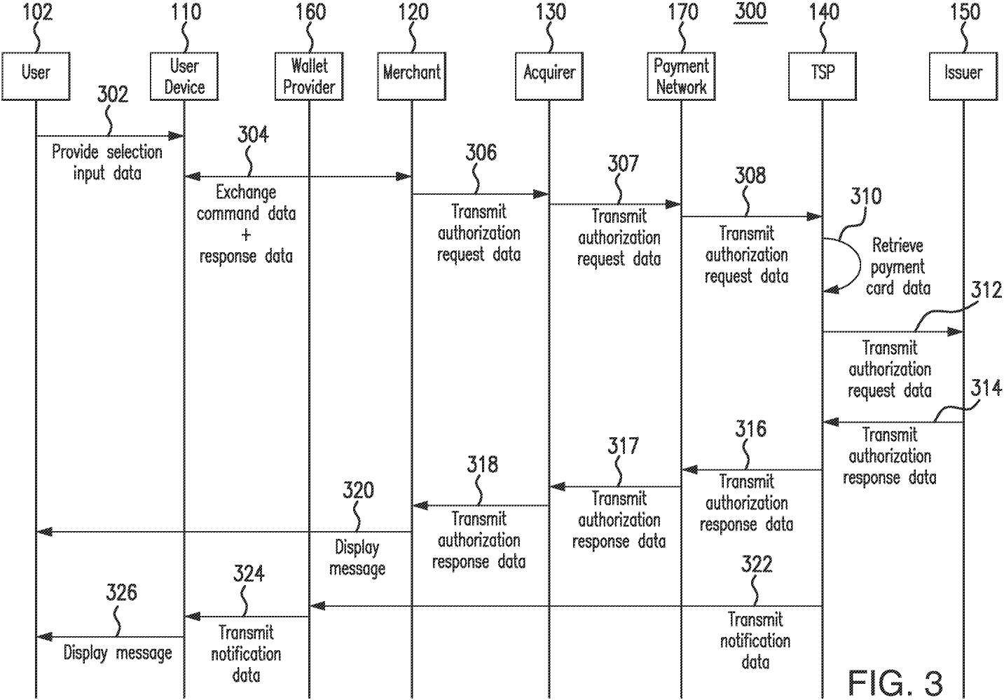

After acquiring the digital token, the user may perform the in-person payment transaction with the merchant by using the wallet application to transmit (e.g., via NFC technology) the digital token from the user device to the merchant POS device. In particular, by transmitting the digital token, the user can perform the in-person payment transaction with the merchant by replacing, or substituting for, the payment card data with the corresponding data of the digital token. Thus, the digital token may be used as a surrogate for the payment card data during the transaction. The merchant may then further perform the in-person payment transaction by transmitting the digital token among one or more other entities (e.g., the acquirer, the TSP, the payment network, and/or the issuer), as is known in the art. In particular, the TSP may map the digital token to the payment card data associated with the digital token. The TSP may then transmit the payment card data, along with the other data relating to the transaction, to the issuer. As noted above, for a successful payment transaction, the issuer may, based on the data from the TSP, provide an authorization response indicating that the payment transaction is approved. One or more implementations for performing a successful payment transaction using a digital token are further described below with respect to FIG. 3.

In some instances, however, the issuer may fail to provide an authorization response indicating that a payment transaction is approved. In such scenarios, if the issuer fails to approve the payment transaction, then the payment transaction may not be funded via the payment account of the user. Such a payment transaction may hereinafter be referred to as a failed payment transaction.

As is known in the art, a failed payment transaction may occur in a variety of scenarios. In one scenario, the failed payment transaction may occur after a communication failure between the user device and the merchant system. In particular, the communication failure may occur before the merchant system can receive the data linked to the payment card (e.g., the payment card data, the digital token, and/or the like). In another scenario, the failed payment transaction may occur after an offline decline response is transmitted from the user device to the merchant system. In such a scenario, based on the offline decline response, the merchant system may fail to transmit the data linked to the payment card (e.g., the payment card data, the digital token, and/or the like) among the one or more entities, including the issuer. In yet another scenario, the failed payment transaction may occur after a communication failure between the merchant system and the TSP. In particular, the communication failure may occur before the issuer can receive data (e.g., the payment card data) from the TSP. In another scenario, the failed payment transaction may occur after the TSP transmits an online decline response to the merchant system, such that the TSP declines to transmit data (e.g., the payment card data) to the issuer. In yet another scenario, the failed payment transaction may occur once the issuer provides an authorization response indicating that the payment transaction is declined.

Furthermore, these scenarios may be due to one or more specific errors among the user device, the merchant system, the acquirer, the payment network, and/or the like. Such errors may include one or more software errors, one or more hardware malfunctions, and/or the like. However, for many of these scenarios, the errors may occur before the TSP and/or other entities can become aware of the attempted payment transaction between the user and the merchant, which may leave the errors unresolved and, therefore, allowed to cause additional failed payment transactions.

In view of the above, various implementations of a system and method for providing transaction report data using a user device are described herein. In some implementations, after a failed payment transaction has been performed using a user device and a merchant system, the user device may generate transaction report data that corresponds to the failed payment transaction. The transaction report data may include data that corresponds to a transaction log of the failed payment transaction, a date and/or time of the failed payment transaction, a location of the failed payment transaction, or combinations thereof. The user device may then transmit the transaction report data to a TSP. In turn, the TSP may analyze the transaction report data. In some implementations, the TSP may generate failure data based on the transaction report data, where the failure data may include alert data and/or failure report data.

### I. System

FIG. 1 illustrates a schematic diagram of a system 100 in accordance with implementations of various techniques described herein. The system 100 may include one or more networks 105, a user 102, a user device 110, a merchant 120, an acquirer 130, a token service provider (TSP) 140, an issuer 150, a wallet provider 160, and a payment network 170.

The user device 110, the merchant 120, the acquirer 130, the TSP 140, the issuer 150, the wallet provider 160, and the payment network 170 may each be configured to communicate with one or more other elements of the system 100 via the one or more networks 105. The one or more networks 105 may include, but are not limited to, one or more of the following networks: a local area network (LAN), a wide area network (WAN) (e.g., the Internet), a mobile network, a virtual network, and/or any other public and/or private network known in the art capable of supporting communication among two or more of the elements of the system 100. In addition, and as further explained later, the user device 110 and the merchant 120 may be configured to communicate with one another using any type of communication known in the art, including, but not limited to, the following: contactless communication, NFC, wireless communication, cellular communication, communication via the one or more networks 105, and/or the like.

As similarly described above, the user 102 may utilize a payment card in order to perform a payment transaction with the merchant 120. The user 102 may be similar to the user mentioned above, such that the user 102 may be any entity known to those skilled in the art. For example, the user 102 may be an individual person, a family, a commercial entity, a company, a corporation, a governmental entity, a non-profit organization, and/or the like. Though FIG. 1 shows the user 102 as being an individual person, those skilled in the art will understand that the implementations disclosed herein can be applied to instances in which the user 102 is any other entity known in the art. Likewise, the merchant 120 may be similar to the merchant mentioned above, such that the merchant 120 may be any entity capable of offering one or more products for sale to the user 102. For example, the merchant 120 may be an individual person, a family, a commercial entity, a company, a corporation, a governmental entity, a non-profit organization, and/or the like. Further, the one or more products may be similar to the products described above.

The payment transaction performed between the user 102 and the merchant 120 may be any transaction known in the art. In particular, the payment transaction may refer to a transaction by the user 102 to purchase the one or more products from the merchant 120 using funds from a payment account linked to the payment card. As is known in the art, the payment transaction may be an in-person payment transaction and/or an online payment transaction between the user 102 and the merchant 120.

As similarly described above, the payment card may be any type of card known in the art, including a physical card or a virtual card. Examples of the payment card may include, but are not limited to, the following: a debit card, a credit card, a prepaid card, a virtual payment card, virtual payment numbers, virtual card numbers, a foreign exchange card, a charge card, a stored-value card, and/or the like. As mentioned above, the payment card may be linked with a payment account of the user 102, such that the user 102 can use the payment card to fund the payment transaction via the payment account. In particular, the user 102 may be an account holder of the payment account. Moreover, the payment account of the user 102 may be similar to the payment account described above, such that the payment account may include any type of financial account known to those skilled in the art that can be used to fund the payment transaction. For example, the payment account may be a banking account, a checking account, a savings account, a credit card account, a debit card account, a prepaid card account, a virtual payment account, and/or the like.

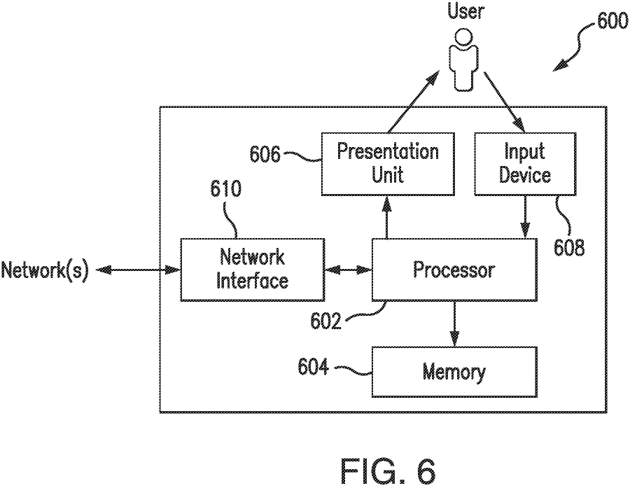

As shown, the user 102 may utilize the user device 110 to perform the payment transaction with the merchant 120 using the payment card. The user 102 may own, operate, and/or be associated with the user device 110, and the user device 110 may be any computing device known to those skilled in the art. For example, the user device 110 may be a mobile device (e.g., a smartphone), a wearable device (e.g., a smartwatch), and/or the like. Various implementations of the user device 110 are discussed later with respect to FIG. 6. Further, the user device 110 may be configured to perform one or more operations described herein, such as communicating with the merchant 120, the TSP 140, the issuer 150, and/or the wallet provider 160 via the one or more networks 105.

In particular, the user 102 may utilize a wallet application 112 stored on the user device 110 to perform the payment transaction using the payment card. The wallet application 112 may be similar to the wallet application discussed above, in that the wallet application 112 may be any type of software application known to those skilled in the art that is configured to store, manage, and/or transmit data relating to a payment account. As shown, the wallet application 112 may be a digital wallet application associated with the wallet provider 160.

In addition, as similarly explained above, prior to performing the payment transaction, the user 102 may initially utilize the wallet application 110 to store data linked to the payment card on the user device 110, such as by storing this data within the wallet application 112 itself. The user 102 may then perform the payment transaction by utilizing the wallet application 112 to transmit the data from the user device 110 to the merchant 120, as further described below. The data linked to the payment card may include payment card data of the payment card, a digital token corresponding to the payment card, and/or the like. The payment card data may be similar to the payment card data described above, such that the payment card data may include, for example, data corresponding to a PAN for the payment card, an expiration date for the payment card, a CVC for the payment card, and/or the like. In addition, the digital token stored on the user device 110 may be similar to the digital token described above. In particular, the digital token may include tokenized data that corresponds to the payment card data of the payment card. For example, the digital token may include data corresponding to a unique alternate card number that can be used to replace a PAN of the payment card in the payment transaction, where the alternate card number may be similar in structure to the PAN. The digital token may also include data that corresponds to an alternate expiration date and/or an alternate CVC that can be used to replace and/or substitute for the expiration date and/or the CVC of the payment card in the payment transaction.

In one implementation, the user 102 may utilize the wallet application 112 to perform one or more operations described herein, including acquiring and storing the digital token on the user device 110. In particular, the user 102 may utilize the wallet application 112 to communicate with the TSP 140 in order to tokenize the payment card data of the payment card, such that the wallet application 112 may receive and store the digital token from the TSP, and where the digital token corresponds to the payment card data. One or more implementations for performing these one or more operations are further described below with respect to FIG. 2.

In another implementation, the user 102 may utilize the wallet application 112 to perform one or more operations described herein, including performing the payment transaction with the merchant 120 by using the wallet application 112 to transmit the digital token from the user device to the merchant 120. As noted above, the user device 110 may be configured to communicate with the merchant 120 using any technique known to those skilled in the art, including, but not limited to, contactless communication, NFC, wireless communication, cellular communication, and/or the like. One or more implementations for performing these one or more operations are further described below, including with respect to FIGS. 3-5.

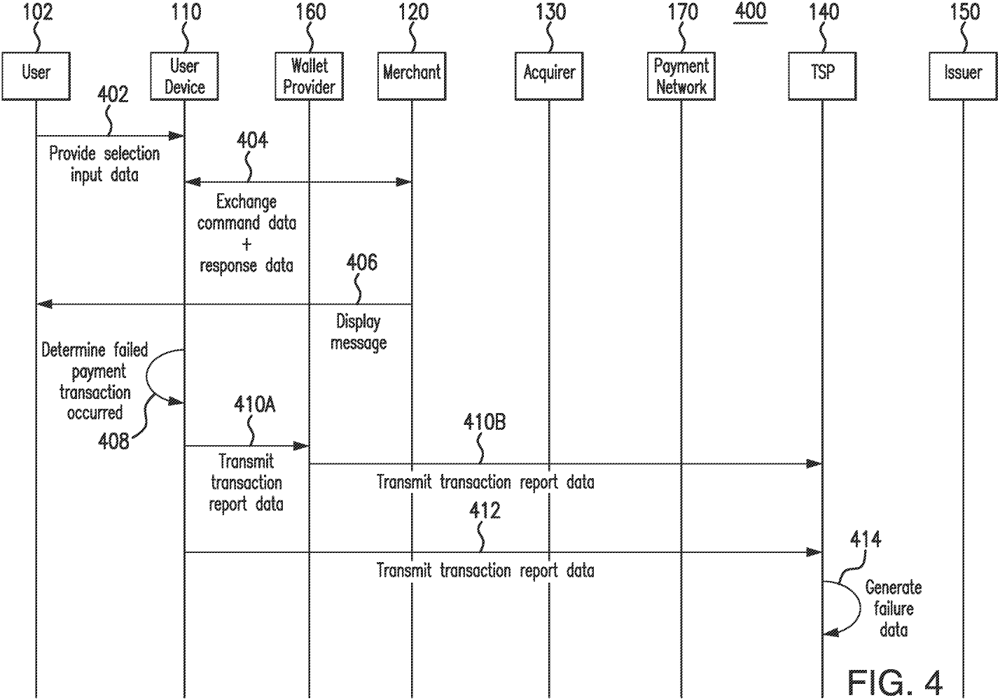

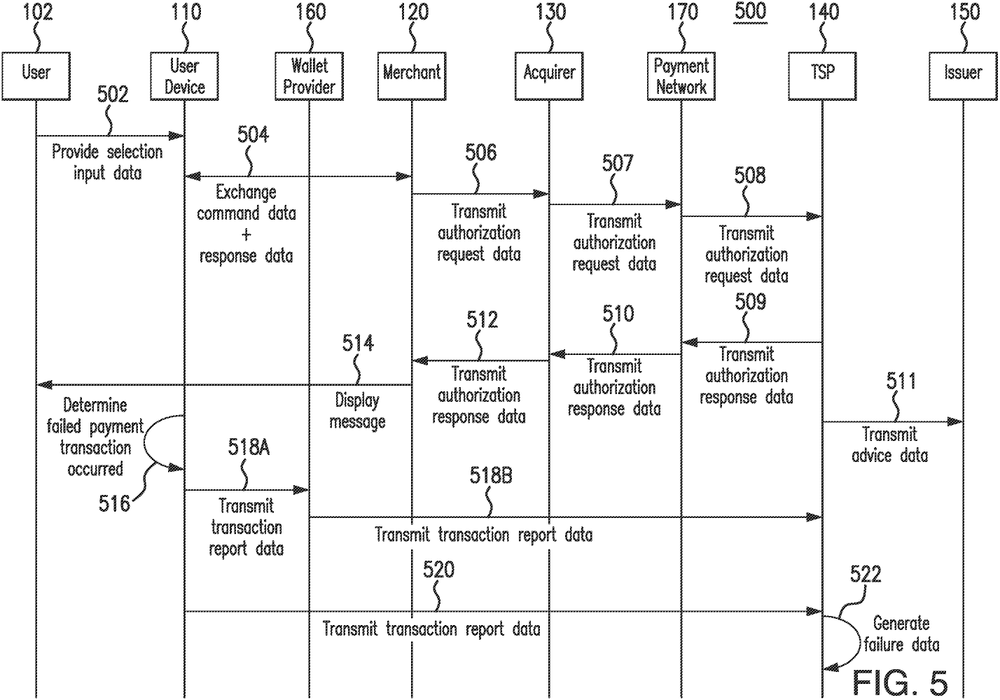

In a further implementation, the wallet application 112 and/or the user device 110 may be configured to perform one or more operations described herein, including determining whether a failed payment transaction has occurred. In particular, the wallet application 112 and/or the user device 110 may determine whether the payment transaction is a failed payment transaction based on one or more of the following: data exchanged with the merchant 120, notification data received from the TSP 140 and/or the issuer 150, and/or the like. Based on the determination, the wallet application 112 and/or the user device 110 may transmit transaction report data to the TSP 140. As further described below, the transaction report data may include data that corresponds to a transaction log of the failed payment transaction, a date and/or time of the failed payment transaction, a location of the failed payment transaction, or combinations thereof. One or more implementations for performing these one or more operations are further described below, including with respect to FIGS. 4 and 5.

The wallet provider 160 may be a digital wallet platform that provisions instances of payment applications, including the wallet application 112, for use in performing the payment transaction. For example, the wallet provider 160 may include Apple Pay®, Samsung Pay®, Google Pay®, and/or the like. In addition, the wallet provider 160 may use one or more computing systems 161 to facilitate communication between the wallet application 112 and the TSP 140. The one or more computing systems 161 may include any computing system known to those skilled in the art, such as one or more servers. Various implementations of the one or more computing systems 161 are discussed later with respect to FIG. 6. As further explained below, the wallet provider 160, through its one or more computing systems 161, may be configured to perform one or more operations described herein, including communicating data between the user device 110 (e.g., via the wallet application 112) and the TSP 140, where such data may include tokenization request data, the digital token, notification data, the transaction report data, and/or the like.

As similarly described above, the TSP 140 be an entity that issues and manages digital tokens, including tokens configured for use in payment transactions. In particular, the TSP 140 may be used to tokenize the payment card data into the digital token for the system 100. The TSP may include and/or may implement any tokenization platform known to those skilled in the art, including the Mastercard Digital Enablement Service (MDES) platform. In addition, the TSP 140 may include, and/or may be implemented using, one or more computing systems 141. The one or more computing systems 141 may include any computing system known to those skilled in the art, such as one or more servers. Various implementations of the one or more computing systems 141 are discussed later with respect to FIG. 6. Further, using its one or more computing systems 141, the TSP 140 may maintain a database (i.e., a token vault) that maps the generated digital token to the payment card data (e.g., data corresponding to the PAN of the payment card) from which the digital token originates.

In one implementation, the TSP 140 (i.e., via the one or more computing systems 141) may be configured to perform one or more operations described herein, including generating and providing the digital token to the user device 110 (e.g., via the wallet application 112) based on the payment card data received from the user device 110 (e.g., via the wallet application 112) and/or the wallet provider 160. One or more implementations for performing these one or more operations are further described below with respect to FIG. 2.

In another implementation, the TSP 140 (i.e., via the one or more computing systems 141) may be configured to perform one or more additional operations described herein, including facilitating the payment transaction using the digital token between the acquirer 130 and the issuer 150. In particular, using the one or more computing systems 141, the TSP 140 may receive an authorization request from the acquirer 130 (e.g., via the payment network 170) to authorize the payment transaction using the digital token. The TSP 140 may then retrieve the payment card data associated with the digital token using its database, transmit the authorization request to the issuer 150 along with the retrieved payment card data, receive an authorization response from the issuer 150, and then transmit the authorization response to the acquirer 130 (e.g., via the payment network 170). In a further implementation, the TSP 140 (i.e., via the one or more computing systems 141) may be configured to generate and transmit notification data to the user device 110 (e.g., via the wallet application 112) and/or the wallet provider 160 based on the authorization response. In particular, the notification data may correspond to a notification indicating that the payment transaction was successful (i.e., the issuer 150 approved the payment transaction) or that the payment transaction had failed (i.e., the issuer 150 declined the payment transaction). For example, the notification data may correspond to one or more transaction details service (TDS) notifications generated by the TSP 140. One or more implementations for performing these one or more operations are further described below, including with respect to FIGS. 3-5.

In yet another implementation, the TSP 140 (i.e., via the one or more computing systems 141) may be configured to perform one or more additional operations described herein, including receiving the transaction report data from the user device 110. The TSP 140 (i.e., via the one or more computing systems 141) may then analyze the transaction report data. Based on the analysis of the transaction report data, the TSP 140 may generate failure data (e.g., alert data and/or failure report data). The alert data may include data that corresponds to one or more alert notifications, such as alert notifications provided to one or more operators of the TSP 140. Examples of the one or more alert notifications may include one or more automated messages, push notifications, emails, and/or the like. In addition, the one or more alert notifications may indicate that a failed payment transaction has occurred and/or that a number of failed payment transactions associated with a particular element of the system 100 (e.g., the user device 110, the merchant 120, the wallet provider 160, the acquirer 130, the payment network 170, and/or the issuer 150) is greater than or equal to a predetermined threshold number, such as for a set period of time. The failure report data may include data that corresponds to one or more failed payment transactions of all transaction report data received by the TSP 140, such as for a set period of time. Further, the failure report data may include the entirety of, or a subset of, the transaction report data received by the TSP 140 for the set period of time. In one example, the TSP 140 (i.e., via the one or more computing systems 141) may generate the failure report data if a number of failed payment transactions associated with a particular element of the system 100 (e.g., the user device 110, the merchant 120, the wallet provider 160, the acquirer 130, the payment network 170, and/or the issuer 150) is greater than or equal to a predetermined threshold number. One or more implementations for performing these one or more operations are further described below, including with respect to FIGS. 4 and 5.

As similarly described above, the issuer 150 may be a financial institution (e.g., a bank, a credit card company, and/or the like) that maintains the payment account for the user 102 and issues the payment card associated with the account to the user 102. In particular, the issuer 150 may use one or more computing systems 151 to facilitate an authorization of the tokenization request from the user device 110 (e.g., via the wallet application 112). In addition, using the one or more computing systems 151, the issuer 150 may be configured to provide the authorization response mentioned above, where the authorization response indicates either an approval or a decline of the payment transaction. The one or more computing systems 151 may include any computing system known to those skilled in the art, such as one or more servers. Various implementations of the one or more computing systems 151 are discussed later with respect to FIG. 6. As further explained below, the issuer 150, through its one or more computing systems 151, may be configured to perform one or more operations described herein, including receiving a tokenization request from the TSP 140, providing a tokenization response to the TSP 140 based on the request, receiving an authorization request from the TSP 140, and transmitting an authorization response to the TSP 140. In a further implementation, the issuer 150 (i.e., via the one or more computing systems 151) may be configured to perform one or more additional operations described herein, including generating and transmitting notification data to the user device 110 (e.g., via the wallet application 112) and/or the wallet provider 160 based on the authorization response. This notification data may be similar to the notification data described above with respect to the TSP 140.

As noted above, the merchant 120 may be any entity capable of offering one or more products for sale to the user 102. In particular, the merchant 120 may use one or more computing systems 121 to communicate with the user device 110 in order to perform the payment transaction, including by communicating with the user device 110. As noted above, using the one or more computing systems 121, the merchant 120 may communicate with the user device 110 using any technique known to those skilled in the art, including, but not limited to, contactless communication, NFC, wireless communication, cellular communication, and/or the like.

Further, the merchant 120 may use its one or more computing systems 121 to communicate with the acquirer 130 in order to further process the payment transaction using the digital token. The one or more computing systems 121 may include any computing system known to those skilled in the art, such as one or more merchant servers, one or more POS devices, one or more automated teller machines (ATMs), one or more point-of-interaction (POI) devices, one or more point-of-purchase (POP) devices, and/or the like. Various implementations of the one or more computing systems 121 are discussed later with respect to FIG. 6. In one example, the one or more computing systems 121 may include a single computing system configured to perform the operations of both the merchant POS device and the merchant server. In another example, the one or more computing systems 121 may include a separate merchant POS device and a separate merchant server configured to communicate with one another using any technique known in the art. As further explained below, the merchant 120, through its one or more computing systems 121, may be configured to perform one or more operations described herein, including receiving the digital token from the user device 110 (e.g., via the wallet application 112), transmitting an authorization request and the digital token to the acquirer 130, and receiving an authorization response via the acquirer 130. In addition, the merchant 120, through its one or more computing systems 121, may be configured to display one or more messages and/or notifications to the user 102.

As similarly described above, the acquirer 130 may be a financial institution (e.g., a bank, a credit card company, and/or the like) that provides one or more services for the processing of payment card-based transactions for the merchant 120. In particular, the acquirer 130 may use one or more computing systems 131 to facilitate an authorization of the payment transaction using the digital token for the merchant 120. The one or more computing systems 131 may include any computing system known to those skilled in the art, such as one or more servers. Various implementations of the one or more computing systems 131 are discussed later with respect to FIG. 6. As further explained below, the acquirer 130, through its one or more computing systems 131, may be configured to receive an authorization request from the merchant 120, transmit the authorization request to the TSP 140 (e.g., via the payment network 170), receive an authorization response from the TSP 140 (e.g., via the payment network 170), and transmit the authorization response to the merchant 120.

As shown in FIG. 1, the system 100 may also include the payment network 170. As similarly described above, the payment network 170 may refer to any network and/or collection of systems that uses one or more computing systems 171 to facilitate the payment transaction for the acquirer 130 and the issuer 150. In particular, the payment network 170 may be a network and/or collection of systems configured to transfer funds through the use of cash-substitutes via any protocols or procedures known in the art. The one or more computing systems 171 may include any computing system known to those skilled in the art, such as one or more servers. Various implementations of the one or more computing systems 171 are discussed later with respect to FIG. 6. As further explained below, the payment network 170, through its one or more computing systems 171, may be configured to receive an authorization request from the acquirer 130, transmit the authorization request to the TSP 140, receive an authorization response from the TSP 140, transmit the authorization response to the acquirer 130, and/or the like.

Additionally, in some implementations, the payment network 170 may be operated by and/or provided by an entity, where the entity may be related to at least one other element of the system 100. In one such implementation, the payment network 170 may also function as the TSP 140 for the system 100, such that the payment network 170 may perform one or more of the operations described herein for the TSP 140. In another implementation, the payment network 170 may be related to the issuer 150 and/or the wallet provider 160, such that the payment network 170 may perform one or more of the operations described herein for the issuer 150 and/or the wallet provider 160. In other implementations, the payment network 170 may be operated by and/or provided by an entity that is separate from and/or unrelated to other elements of the system 100. Examples of the payment network 170 may include those operated by Mastercard®.

The one or more computing systems mentioned above may be implemented using one or more software-based systems, one or more hardware-based systems, or combinations thereof. Further, the one or more computing systems mentioned above, including the user device 110, may be configured to perform the one or more operations described herein using one or more applications downloaded to, installed in, and/or active in these one or more computing systems. In addition, the one or more computing systems mentioned above, including the user device 110, may communicate with one another using any technique known to those skilled in the art. For example, though not shown in FIG. 1, these one or more computing systems may communicate with one another using one or more application programming interfaces (APIs) associated with the one or more applications. In another example, the one or more applications used by at least some of the computing systems may include a web browser, such that the web browser may be used to communicate with other computing systems of the system 100 via the one or more networks 105.

Moreover, although the system 100 is presented in one arrangement, other implementations may include one or more elements of the system 100 in different arrangements and/or with additional elements. For example, though one merchant 120 is shown in FIG. 1, those skilled in the art will understand that the implementations described herein may be applied to a plurality of merchants 120. In another example, though one user 102 is shown in FIG. 1, those skilled in the art will understand that the implementations described herein may be applied to a plurality of users 102. In yet another example, though the above implementations are primarily described with respect to the use of a digital token to perform the payment transaction, those skilled in the art will understand that the implementations described herein may be applied to performing the payment transaction using payment card data.

### II. Operation

One or more elements of the system 100 may be used to perform one or more operations, such as those described below, to utilize transaction report data that corresponds to a failed payment transaction between the user 102 and the merchant 120. In particular, the user device 110 may be used to determine whether the failed payment transaction has occurred. Based on the determination, the user device 110 may generate the transaction report data, where the transaction report data may include data that corresponds to a transaction log of the failed payment transaction, a date and/or time of the failed payment transaction, a location of the failed payment transaction, or combinations thereof. After generating the transaction report data, the user device 110 may transmit the transaction report data to the one or more computing systems 141 of the TSP 140. The one or more computing systems 141 may then generate failure data based on the transaction report data, where the failure data may include alert data and/or failure report data.

### A. Tokenization

As noted above, prior to performing the payment transaction with the merchant 120, the user 102 may utilize the user device 110 (e.g., via the wallet application 112) to perform a tokenization process for the payment card data of the payment card, such that the digital token may be provisioned to the user device 110 by the TSP 140. In particular, prior to performing the payment transaction, the user 102 may utilize the wallet application 110 to acquire and then store the digital token on the user device 110, where the digital token may include tokenized data that corresponds to the payment card data of the payment card.

FIG. 2 illustrates a sequencing diagram 200 in accordance with implementations of various techniques described herein. In particular, the sequencing diagram 200 may represent an implementation of a process by the system 100, where the system 100 may be used to provide the digital token to the user device 110. While the sequencing diagram is discussed with respect to FIG. 1, those skilled in the art will understand that implementations may not limited to the operation and/or the system discussed below.

Though not shown in FIG. 2, in order to acquire and store the digital token, the user 102 may initially download, install, and/or activate the wallet application 112 on the user device 110. In other implementations, the wallet application 112 may have been pre-installed on the user device 110.

At 202, the user 102 may provide token input data to the user device 110 (e.g., via the wallet application 112), where the token input data corresponds to a request by the user 102 to acquire the digital token corresponding to the payment card. In one implementation, the wallet application 112 may use a presentation unit of the user device 110 to display a prompt to the user 102, where the prompt indicates an option to request a digital token for one or more payment cards of the user 102. The user 102 may then use an input device of the user device 110 to provide the token input data to the wallet application 112, where the token input data indicates a request to acquire the digital token for a particular payment card.

At 204, in response to the token input data from the user 102, the user device 110 (i.e., via the wallet application 112) may transmit tokenization request data for the payment card to the one or more computing systems 161 of the wallet provider 160. The tokenization request data may include data corresponding to a request for the issuer 150 to authorize the creation of the digital token for the payment card, where the issuer 150 is associated with the payment card. In particular, the issuer 150 may maintain the payment account associated with the payment card of the user and may issue the payment card to the user.

The tokenization request data may also include the payment card data for the payment card. As noted above, the payment card data may include data corresponding to the PAN for the payment card, the expiration date for the payment card, the CVC for the payment card, and/or the like. In particular, the user 102 may provide the payment card data to the user device 110 (e.g., via the wallet application 112) before, during, or after providing the token input data. In one example, the user 102 may use the input device of the user device 110 to provide the payment card data to the wallet application 112.

In a further implementation, the tokenization request data may also include authentication data corresponding to the user 102, where the authentication data includes data that can be used by the issuer 150 to verify that the user 102 is associated with the payment card (e.g., the user 102 is the account holder). The authentication data may include any data known in the art, such as data corresponding to a personal identification number (PIN) associated with the payment card.

At 206, the wallet provider 160, using its one or more computing systems 161, may transmit the tokenization request data to the one or more computing systems 141 of the TSP 140. At 208, the TSP 140, using its one or more computing systems 141, may then transmit the tokenization request data to the one or more computing systems 151 of the issuer 150. In one implementation, the issuer 150, via its one or more computing systems 151, may perform an authorization process using the tokenization request data. In particular, the authorization process may be used to determine if the digital token is to be generated by the TSP 140. In a further implementation, the authorization process may include authenticating the user 102 based on the authentication data.

At 210, the issuer 150, using its one or more computing systems 151, may transmit tokenization response data to the one or more computing systems 141 of the TSP 140. In one implementation, the tokenization response data may include data indicating that the issuer 150 authorizes the creation of the digital token by the TSP 140. In another implementation, the tokenization response data may include data indicating that the issuer 150 declines to authorize the creation of the digital token by the TSP 140. With respect to FIG. 2, the issuer 150 authorizes the creation of the digital token.

At 212, based on the tokenization response data, the TSP 140 may then use its one or more computing systems 141 to perform a tokenization process in order to generate the digital token for the payment card. As noted above, the digital token may include tokenized data that corresponds to the payment card data of the payment card. For example, the digital token may include data corresponding to a unique alternate card number that can be used to replace a PAN of the payment card in the payment transaction, where the alternate card number may be similar in structure to the PAN. The digital token may also include data that corresponds to an alternate expiration date and/or an alternate CVC that can be used to replace the expiration date and/or the CVC of the payment card in the payment transaction. Thus, payment transactions performed using digital tokens may be more secure, as the actual card information (e.g., a PAN) may be replaced in the payment transaction process and, thus, protected against theft and misuse.

In addition, the TSP 140, using its one or more computing systems 141, may also store the digital token and its associated payment card data in a database of the one or more computing systems 141. The database may also be referred to herein as a token vault. In particular, the digital token and the associated payment card data may be mapped within the database for use in subsequent payment transaction authorizations, as further described below.

At 214, the TSP 140, using its one or more computing systems 141, may then transmit the digital token to the one or more computing systems 161 of the wallet provider 160. At 216, the wallet provider 160, using its one or more computing systems 161, may transmit the digital token to the user device 110 (e.g., via the wallet application 112). In another implementation, the TSP 140, using its one or more computing systems 141, may directly transmit the digital token to the user device 110 (e.g., via the wallet application 112). At 218, the user device 110 may store the digital token via the wallet application 112.

### B. Successful Payment Transaction

As similarly described above, after acquiring and storing the digital token using the user device 110, the user 102 may then utilize the user device 110 (e.g., via the wallet application 112) to perform the payment transaction using the digital token. In particular, the user 102 may perform the payment transaction by utilizing the user device 110 (e.g., via the wallet application 112) to transmit the digital token to the one or more computing systems 121 of the merchant 120. As noted above, the user device 110 may be configured to communicate with the merchant 120 (i.e., via the one or more computing systems 121) using any technique known to those skilled in the art, including, but not limited to, contactless communication, NFC, wireless communication, cellular communication, and/or the like.

As mentioned above, for a successful payment transaction, the issuer 150 may provide an authorization response indicating that the payment transaction is approved. In such a scenario, after the issuer 150 approves the payment transaction, the payment transaction may be funded via a transfer of funds between the payment account of the user 102 and a financial account of the merchant 120.

FIG. 3 illustrates a sequencing diagram 300 in accordance with implementations of various techniques described herein, where the sequencing diagram 300 represents an implementation in which a successful payment transaction is performed between the user 102 and the merchant 120 using the digital token. While the sequencing diagram is discussed with respect to FIGS. 1 and 2, those skilled in the art will understand that implementations may not be limited to the operation and/or system discussed below.

With respect to FIG. 3, the user 102 (i.e., via the user device 110) may initiate a payment transaction with the merchant 120 (i.e., via the one or more computing systems 121) in order to purchase one or more products from the merchant 120. The user device 110 (including the wallet application 112) and the one or more computing systems 121 may be configured to process the payment transaction in accordance with any standards, protocols, and/or specifications known in the art. In one example, the payment transaction may be a chip-based payment transaction, such that the user device 110 and/or the wallet application 112 may be configured to emulate a physical payment card having an integrated circuit (e.g., a chip card, a smart card, and/or the like) when processing the transaction. In such an example, the user device 110 and/or the wallet application 112 may be configured to process the payment transaction and communicate with the merchant 120 in accordance with EMV-based standards, protocols, and/or specifications, as is known in the art. In another example, the payment transaction may be magnetic stripe-based payment transaction, such that the user device 110 and/or the wallet application 112 may be configured to emulate a physical payment card having a magnetic stripe when processing the transaction. In such an example, the user device 110 and/or the wallet application 112 may be configured to process the payment transaction and communicate with the merchant 120 in accordance with any standards, protocols, and/or specifications associated with magnetic stripe-based payment transactions known in the art. In yet another example, the payment transaction may be a Quick Response (QR) code-based transaction. In such an example, the user device 110 and/or the wallet application 112 may be configured to process the payment transaction and communicate with the merchant 120 in accordance with any QR code-based standards, protocols, and/or specifications known in the art (e.g., Mastercard Consumer Presented QR).

At 302, to initiate the payment transaction with the merchant 120, the user 102 may provide selection input data to the user device 110. The selection input data may correspond to a selection of the wallet application 112 for use in performing the payment transaction using a digital token. In one implementation, the wallet application 112 may process the payment transaction using a digital token that had been previously selected by the user 102, using a digital token that had been previously designated as a default selection for use in payment transactions, and/or the like.

At 304, to perform the payment transaction between the user 102 and the merchant 120, the user device 110 (e.g., via the wallet application 112) and the merchant 120 (i.e., via the one or more computing systems 121) may exchange command data and response data. In one implementation, the exchange of this data may occur if the user device 110 and at least one computing device 121 (e.g., a merchant POS device) of the merchant 120 are sufficiently proximate to each other to perform a contactless payment transaction, such as through NFC technology. In such an implementation, the payment transaction between the user 102 and the merchant 120 may be an in-person payment transaction. In another implementation, the user device 110 and the merchant 120 (i.e., via the one or more computing systems 121) may exchange this data after the one or more computing devices 121 receive the digital token from the user device 110 (e.g., via the wallet application 112). In such an implementation, the payment transaction between the user 102 and the merchant 120 may be an online payment transaction.

In particular, the merchant 120 (i.e., via the one or more computing systems 121) may transmit the command data to the user device 110. In turn, the user device 110 (e.g., via the wallet application 112) may transmit the response data to the merchant 120 (i.e., via the one or more computing systems 121) after processing the command data. The user device 110 and the merchant 120 may exchange the command data and the response data in accordance with any standards, protocols, and/or specifications known to those skilled in the art (e.g., EMV-based standards or magnetic stripe-based standards).

For implementations in which the payment transaction is a chip-based payment transaction, the exchanged data may be in the form of application protocol data units (APDUs). In particular, the command data transmitted by the merchant 120 (i.e., via the one or more computing systems 121) may be command APDUs, and the response data transmitted by the user device 110 (e.g., via the wallet application 112) may be response APDUs.

In such implementations, the merchant 120 (i.e., via the one or more computing systems 121) may initially transmit a command APDU that corresponds to a command for the user device 110 to provide its stored EMV data to the merchant 120. For example, this command APDU may correspond to a Read Record command by the merchant 120 (i.e., via the one or more computing systems 121), as is known in the art. The EMV data stored on the user device 110 may include data relating to one or more cryptographic keys, one or more digital certificates, one or more personal identification numbers (PINs), cardholder verification method (CVM) data, and/or the like. In turn, the user device 110 (e.g., via the wallet application 112) may transmit the EMV data to the merchant 120 (i.e., via the one or more computing systems 121) using one or more response APDUs.

The merchant 120 (i.e., via the one or more computing systems 121) may then process the EMV data received from the user device 110 in order to determine whether to continue performing the payment transaction between the user 102 and the merchant 120. For example, the merchant 120 (i.e., via the one or more computing systems 121) may process the EMV data by: determining if there are any processing restrictions; performing one or more CVMs; performing an offline data authentication, including a combined dynamic data authentication/generate application cryptogram (CDA); or combinations thereof. The merchant 120 (i.e., via the one or more computing systems 121) may also set the bits of a terminal verification results (TVR) data object based on the processing of the EMV data.

Further, based on the processing of the EMV data from the user device 110, the merchant 120 (i.e., via the one or more computing systems 121) may generate an authorization decision regarding the payment transaction, where the authorization decision represents a determination as to whether the user device 110 is to continue performing the payment transaction. As is known in the art, the authorization decision may be an offline approval decision by the merchant 120, an offline decline decision by the merchant 120, or a decision by the merchant 120 that an online authorization by the issuer 150 is to be performed. The merchant 120 (i.e., via the one or more computing systems 121) may then transmit a particular command APDU to the user device 110 (e.g., via the wallet application 112) based on this authorization decision.

For example, based on the TVR data object, the merchant 120 (i.e., via the one or more computing systems 121) may transmit a command APDU to the user device 110 requiring that the user device 110 generate an application cryptogram (AC) and also transmit the AC to the merchant 120 (i.e., via the one or more computing systems 121), where the command APDU specifies the particular AC. As is known in the art, the AC requested in the command APDU may include a transaction certificate (TC) indicating an offline approval decision by the merchant 120, an application authentication cryptogram (AAC) indicating an offline decline decision by the merchant 120, or an authorization request cryptogram (ARQC) indicating a decision by the merchant 120 that an online authorization is to be performed. Upon receiving the command APDU specifying the required AC, the user device 110 (e.g., via the wallet application 112) may transmit a response APDU that includes the AC specified in the command APDU, transmit a response APDU that includes the AAC based on an offline decline decision by the user device 110, or transmit a response APDU that includes the ARQC based on an online authorization decision by the user device 110.

For implementations in which the payment transaction is a magnetic stripe-based payment transaction, the merchant 120 (i.e., via the one or more computing systems 121) may initially transmit command data that corresponds to a command for the user device 110 to provide its stored data to the merchant 120. For example, the command data may correspond to a Read Record command by the merchant 120 (i.e., via the one or more computing systems 121), as is known in the art. In turn, the user device 110 (e.g., via the wallet application 112) may transmit the response data, which includes the stored data, to the merchant 120 (i.e., via the one or more computing systems 121). The response data transmitted by the user device 110 may include the data of the digital token (e.g., alternate PAN, alternate expiration date, and/or the like). In addition, the merchant 120 (i.e., via the one or more computing systems 121) may also transmit command data that causes the user device 110 (e.g., via the wallet application 112) to generate a dynamic CVC, where such command data may include, for example, a Compute Cryptographic Checksum (CCC) command. In response to receiving this command data, the user device 110 (e.g., via the wallet application 112) may generate the dynamic CVC, such that the dynamic CVC may be included in the response data transmitted to the merchant 120.

Based on the response data from the user device 110 (e.g., a response APDU that includes the ARQC, response data that includes the dynamic CVC, and/or the like), the merchant 120 (i.e., via the one or more computing systems 121) may generate authorization request data. The authorization request data may include data corresponding to a request for the issuer 150 to approve the payment transaction using the payment card, where the issuer 150 is associated with the payment card. As noted above, after the issuer approves the payment transaction, the payment transaction may be funded via a transfer of funds between the payment account of the user and a financial account of the merchant. Again, such a payment transaction would be a successful payment transaction, as defined herein. As is known in the art, the authorization request data may include data corresponding to the digital token, a transaction amount of the payment transaction, a time of the payment transaction, an identifier of the particular computing system 121 (e.g., a merchant POS device) used in the payment transaction, a transaction identifier, at least a portion of the response data (e.g., the response APDU that includes the ARQC) from the user device 110, and/or the like.

At 306, the merchant 120 (i.e., via the one or more computing systems 121) may transmit the authorization request data to the one or more computing systems 131 of the acquirer 130. At 307, the acquirer (i.e., via the one or more computing systems 131) may transmit the authorization request data to the one or more computing systems 171 of the payment network 170. At 308, the payment network 170, using its one or more computing systems 171, may transmit the authorization request data to the one or more computing systems 141 of the TSP 140. At 310, using its one or more computing systems 141, the TSP 140 may retrieve the payment card data corresponding to the digital token of the authorization request data. In one implementation, the TSP 140 (i.e., via the one or more computing systems 141) may retrieve the payment card data using the database (i.e., the token vault) discussed with respect to FIG. 2. In particular, the TSP 140 (i.e., via the one or more computing systems 141) may use this database to map the digital token to its associated payment card data. This payment card data may include data corresponding to the PAN for the payment card, the expiration date for the payment card, the CVC for the payment card, and/or the like.

At 312, using its one or more computing systems 141, the TSP 140 (i.e., via the one or more computing systems 141) may transmit the authorization request data to the one or more computing systems 151 of the issuer 150, where this authorization request data includes the payment card data in place of the digital token. In one implementation, before transmitting the authorization request data, the TSP 140 (i.e., via the one or more computing systems 141) may, on behalf of the issuer 150, validate the response data received from the user device 110 and included in the authorization request data. The TSP 140 (i.e., via the one or more computing systems 141) may validate the response data using any technique known in the art. Upon a successful validation, the TSP 140 (i.e., via the one or more computing systems 141) may transmit the authorization request data to the one or more computing systems 151 of the issuer 150. For an unsuccessful validation, the TSP 140 (i.e., via the one or more computing systems 141) may provide an online decline response to the merchant 120, such that the TSP 140 declines to transmit the authorization request data to the issuer 150, as further described later.

Based on the received authorization request data, the issuer 150 (i.e., via the one or more computing systems 151) may generate authorization response data. The authorization response data may include data indicating that the issuer 150 approves or declines the payment transaction. As noted above, for a successful payment transaction, the issuer 150 (i.e., via the one or more computing systems 151) may generate authorization response data indicating that the payment transaction is approved. In particular, after the approval of the payment transaction, the payment transaction may be funded via a transfer of funds between the payment account of the user 102 and a financial account of the merchant 120. In contrast, for a failed payment transaction, the issuer 150 (i.e., via the one or more computing systems 151) may generate authorization response data indicating that the payment transaction is declined. With respect to FIG. 3, the authorization response data indicates that the payment transaction is approved.

In some implementations, the issuer 150 (i.e., via the one or more computing systems 151) may generate the authorization response data based on one or more financial assessments of the payment transaction. The one or more financial assessments may include whether the payment account of the payment card is in good standing, whether the payment account of the payment card includes sufficient funds or credit, fraud scoring, and/or the like. In other implementations, the issuer 150 (i.e., via the one or more computing systems 151) may generate the authorization response data after successfully validating the response data received from the user device 110 (e.g., the application cryptogram) and included in the authorization request data. The issuer 150 may validate the response data using any technique known in the art.

At 314, using its one or more computing systems 151, the issuer 150 may transmit the authorization response data to the one or more computing systems 141 of the TSP 140. At 316, using its one or more computing systems 141, the TSP 140 may transmit the authorization response data to the one or more computing systems 171 of the payment network 170. At 317, using its one or more computing systems 171, the payment network 170 may transmit the authorization response data to the one or more computing systems 131 of the acquirer 130. At 318, the acquirer 130, using its one or more computing systems 131, may transmit the authorization response data to the one or more computing systems 121 of the merchant 120. At 320, the one or more computing systems 121 of the merchant 120 may display a message to the user 102, where the message indicates that the payment transaction is approved. In one implementation, the one or more computing systems 121 may use a presentation unit to display the message.

As noted above, the TSP 140 (i.e., via the one or more computing systems 141) and/or the issuer 150 (i.e., via the one or more computing systems 151) may be configured to generate notification data based on the authorization response data. In particular, the notification data may correspond to a notification indicating that the payment transaction was successful (i.e., the issuer 150 approved the payment transaction) or that the payment transaction had failed (i.e., the issuer 150 declined the payment transaction). For example, the notification data may correspond to one or more TDS notifications generated by the TSP 140 (i.e., via the one or more computing systems 141) and/or the issuer 150 (i.e., via the one or more computing systems 151). With respect to FIG. 3, the notification data indicates that the payment transaction was successful and is transmitted by the TSP 140 (i.e., via the one or more computing systems 141).

At 322, using its one or more computing systems 141, the TSP 140 may transmit the notification data to the one or more computing systems 161 of the wallet provider 160. At 324, using its one or more computing systems 161, the wallet provider 160 may transmit the notification data to the user device 110 (e.g., via the wallet application 112). At 326, the user device 110 (e.g., via the wallet application 112) may display a message to the user 102 based on the notification data, where the message indicates that the payment transaction was successful. In one implementation, the wallet application 112 may use the presentation unit of the user device 110 to display the message to the user 102.

### C. Failed Transaction Process

As noted above, after acquiring and storing the digital token using the user device 110, the user 102 may then utilize the user device 110 (e.g., via the wallet application 112) to perform the payment transaction with the merchant 120 using the digital token. In contrast to the payment transaction discussed with respect to FIG. 3, in some implementations, the issuer 150 (i.e., via the one or more computing systems 151) may fail to provide authorization response data indicating that the payment transaction is approved. In such implementations, if the issuer 150 fails to approve the payment transaction, then the payment transaction may not be funded via the payment card of the user 102. Thus, the payment transaction may be a failed payment transaction.

As explained above, the failed payment transaction may occur in a variety of scenarios. Moreover, these scenarios may be due to one or more specific errors among the user device 110, the merchant 120, the acquirer 130, the payment network 170, and/or the like. Such errors may include one or more software errors, one or more hardware malfunctions, and/or the like. In addition, the errors may occur before the TSP 140 (e.g., via the one or more computing devices 141) and/or other entities can become aware of the attempted payment transaction between the user 102 and the merchant 120, which may leave the errors unresolved and, therefore, allowed to cause additional failed payment transactions. Accordingly, in some implementations, the user device 110 (e.g., via the wallet application 112) may generate transaction report data that corresponds to the failed payment transaction. The transaction report data may include data that corresponds to a transaction log of the failed payment transaction, a date and/or time of the failed payment transaction, a location of the failed payment transaction, or combinations thereof.

FIG. 4 illustrates a sequencing diagram 400 in accordance with implementations of various techniques described herein. In particular, the sequencing diagram 400 may represent an implementation of a process by the system 100, where the system 100 may be utilized to provide transaction report data corresponding to a failed payment transaction. While the sequencing diagram is discussed with respect to FIGS. 1-3, those skilled in the art will understand that implementations may not be limited to the operation and/or system discussed below.

With respect to FIG. 4, the user 102 (i.e., via the user device 110) may initiate a payment transaction with the merchant 120 (i.e., via the one or more computing systems 121) in order to purchase one or more products from the merchant 120. As explained above, the user device 110 (including the wallet application 112) and the one or more computing systems 121 may be configured to process the payment transaction in accordance with any standards, protocols, and/or specifications known in the art (e.g., EMV-based standards, magnetic stripe-based standards, QR code-based standards, and/or the like).

At 402, to initiate the payment transaction with the merchant 120, the user 102 may provide selection input data to the user device 110. The selection input data may correspond to a selection of the wallet application 112 for use in performing the payment transaction using a digital token. In one implementation, the wallet application 112 may process the payment transaction using a digital token that had been previously selected by the user 102, using a digital token that had been previously designated as a default selection for use in payment transactions, and/or the like.

At 404, to perform the payment transaction between the user 102 and the merchant 120, the user device 110 (e.g., via the wallet application 112) and the merchant 120 (i.e., via the one or more computing systems 121) may exchange command data and response data. The command data and the response data may be similar to the command data and the response data described above with respect to FIG. 3. Further, the implementations of 404 may be similar to the implementations of 304 described above with respect to FIG. 3.

In addition, as shown in FIG. 4, the payment transaction may fail before the merchant 120 (i.e., via the one or more computing systems 121) can transmit authorization request data to the one or more computing systems 131 of the acquirer 130. As a result, the issuer 150 (i.e., via the one or more computing systems 151) does not receive this authorization request data and, consequently, fails to provide authorization response data indicating that the payment transaction is approved. Thus, the payment transaction of FIG. 4 is a failed payment transaction.

The issuer 150 (i.e., via the one or more computing systems 151) may fail to receive the authorization request data and, therefore, may fail to provide the authorization response data (as shown in FIG. 4) in any number of scenarios. In one implementation with respect to FIG. 4, the issuer 150 may fail to receive the authorization request data and, in turn, may fail to provide the authorization response data due to one or more communication failures between the user device 110 and the merchant 120 (i.e., via the one or more computing systems 121), such as for a torn transaction. As is known in the art, a torn transaction may refer to an initiated payment transaction in which the user 102 repositions the user device 110 before the payment transaction has been completed, such that the user device 110 and a computing device 121 (e.g., a merchant POS device) of the merchant 120 are no longer sufficiently proximate to each other to establish communication. In particular, for a torn transaction, this communication failure may occur before the merchant 120 (i.e., via the one or more computing systems 121) can transmit the authorization request data to the one or more computing systems 131 of the acquirer 130. As a result, for a torn transaction, the issuer 150 (i.e., via the one or more computing systems 151) may fail to receive the authorization request data and, therefore, may fail to provide the authorization response data, as shown in FIG. 4.

For example, an initiated chip-based payment transaction may become a torn transaction if the communication failure occurs before the user device 110 (e.g., via the wallet application 112) receives command data (e.g., a command APDU) from the merchant 120 (i.e., via the one or more computing systems 121) requiring that the user device 110 generate an AC, as described above. Such command data may hereinafter be referred to as generate AC command data. In addition, an initiated chip-based payment transaction may become a torn transaction if the communication failure occurs before the user device 110 (e.g., via the wallet application 112) transmits response data (e.g., a response APDU) that includes an AC (e.g., an ARQC) to the merchant 120, as described above. In another example, an initiated magnetic stripe-based payment transaction may become a torn transaction if the communication failure occurs before the user device 110 (e.g., via the wallet application 112) is able to receive command data from the merchant 120 (i.e., via the one or more computing systems 121) that causes the user device 110 (e.g., via the wallet application 112) to generate a dynamic CVC, such as the CCC command mentioned above. Such command data may hereinafter be referred to as generate dynamic CVC command data. In addition, an initiated magnetic stripe-based payment transaction may become a torn transaction if the communication failure occurs before the user device 110 (e.g., via the wallet application 112) is able to transmit response data that includes the dynamic CVC to the merchant 120, as described above.

In another implementation with respect to FIG. 4, for a chip-based payment transaction, the issuer 150 may fail to receive the authorization request data and, in turn, may fail to provide the authorization response data due to an offline decline decision by the merchant 120 (i.e., via the one or more computing systems 121) and/or the user device 110 (e.g., via the wallet application 112). As noted above, the merchant 120 (i.e., via the one or more computing systems 121) may process the EMV data received from the user device 110 to determine whether to continue performing the payment transaction. Such processing may include: determining if there are any processing restrictions; performing one or more CVMs; performing an offline data authentication, including a CDA; or combinations thereof. In one example, based on this processing of the EMV data, the merchant 120 (i.e., via the one or more computing systems 121) may generate an offline decline decision, as described above. The merchant 120 (i.e., via the one or more computing systems) may then transmit a command APDU requiring that the user device 110 generate the AAC and also transmit the AAC to the merchant 120. In another example, based on the generate AC command data from the merchant 120, the user device 110 may generate an offline decline decision and transmit a response APDU that includes the AAC, as also described above. The offline decline decision may represent a determination that the payment transaction is to be declined without sending the authorization request data to the issuer 150. Thus, for implementations in which the offline decline decision is generated by the merchant 120 and/or the user device 110, the issuer 150 (i.e., via the one or more computing systems 151) may fail to receive the authorization request data and, therefore, may fail to provide the authorization response data.

In yet another implementation with respect to FIG. 4, the issuer 150 may fail to receive the authorization request data and, in turn, may fail to provide the authorization response data due to one or more communication failures between the merchant 120 (i.e., via the one or more computing systems 121) and the TSP 140 (i.e., via the one or more computing systems 141). In such an implementation, the merchant 120 (i.e., via the one or more computing systems 121) may attempt to transmit the authorization request data to the one or more computing systems 131 of the acquirer 130. However, the TSP 140 may not receive the authorization request data due to one or more communication failures between the merchant 120, the acquirer 130, the payment network 170, and/or the TSP 140, Thus, for such an implementation, the issuer 150 (i.e., via the one or more computing systems 151) may fail to receive the authorization request data and, therefore, may fail to provide the authorization response data.

At 406, the one or more computing systems 121 of the merchant 120 may display a message to the user 102, where the message indicates that the failed payment transaction has occurred. In one implementation, the one or more computing systems 121 may use a presentation unit to display the message. In some implementations, the message may indicate the scenario in which the failed payment transaction has occurred. For example, the message may indicate that there was a communication failure between the merchant 120 and the TSP 140.

At 408, the user device 110 (e.g., via the wallet application 112) may determine whether a failed payment transaction has occurred. In some implementations, to make such a determination, the user device 110 and/or the wallet application 112 may first determine whether a payment transaction between the user 102 and the merchant 120 had been initiated. The user device 110 and/or the wallet application 112 may make such a determination using any technique known to those skilled in the art. In one implementation, the user device 110 and/or the wallet application 112 may determine that a payment transaction had been initiated based on the command data and the response data exchanged with the merchant 120 (i.e., via the one or more computing systems 121), including the command data and the response data described above with respect to FIG. 3. In one example, the user device 110 (e.g., via the wallet application 112) may determine that a payment transaction had been initiated based on the receipt of any command data from the merchant 120 (i.e., via the one or more computing systems 121). In another example, the user device 110 (e.g., via the wallet application 112) may determine that a payment transaction had been initiated based on the receipt of a command APDU (e.g., a Read Record command) requiring that the user device 110 provide its stored EMV data to the merchant 120 (i.e., via the one or more computing systems 121), as described above.

Upon determining that the payment transaction between the user 102 and the merchant 120 had been initiated, the user device 110 and/or the wallet application 112 may then determine whether the payment transaction is a failed payment transaction. As explained above, with respect to FIG. 4, the issuer 150 may fail to receive the authorization request data and, therefore, may fail to provide the authorization response data (i.e., resulting in a failed payment transaction) in any number of scenarios, including, but not limited to, the following: the payment transaction has become a torn transaction; an offline decline decision has been made by the merchant 120 and/or the user device 110; or one or more communication failures have occurred between the merchant 120 and the TSP 140.

In one implementation, for an initiated chip-based payment transaction, the user device 110 (e.g., via the wallet application 112) may determine that a failed payment transaction has occurred if the user device 110 fails to receive the generate AC command data (as described above) or fails to transmit response data (e.g., a response APDU) that includes an AC (e.g., an ARQC) to the merchant 120 (as described above). In another implementation, for an initiated magnetic stripe-based payment transaction, the user device 110 (e.g., via the wallet application 112) may determine that a failed payment transaction has occurred if the user device 110 fails to receive the generate dynamic CVC command data (as described above) or fails to transmit response data that includes the dynamic CVC to the merchant 120 (as described above). Thus, in such implementations, the user device 110 (e.g., via the wallet application 112) may be able to determine that a failed payment transaction has occurred for a torn transaction. In addition, the user device 110 (e.g., via the wallet application 112) may make such a determination after a predetermined amount of time has elapsed since the initiation of the payment transaction.

In yet another implementation, for an initiated chip-based payment transaction, the user device 110 (e.g., via the wallet application 112) may determine that a failed payment transaction has occurred if the generate AC command data received from the merchant 120 requires that the user device 110 generate the AAC, which is indicative of an offline decline decision by the merchant 120, as described above. In another implementation, for an initiated chip-based payment transaction, the user device 110 (e.g., via the wallet application 112) may determine that a failed payment transaction has occurred if the user device 110 transmits a response APDU that includes the AAC based on an offline decline decision by the user device 110, as described above.

In another implementation, the user device 110 (e.g., via the wallet application 112) may determine that the payment transaction is a failed payment transaction based on a failure to receive notification data from the wallet provider 160, the TSP 140, and/or the issuer 150. As noted above, the notification data may correspond to a notification indicating that the payment transaction was successful (i.e., the issuer 150 approved the payment transaction) or that the payment transaction had failed (i.e., the issuer 150 declined the payment transaction). Thus, the failure to receive the notification data at the user device 110 may indicate that the issuer 150 (i.e., via the one or more computing systems 151) failed to provide authorization response data indicating that the payment transaction is approved. Accordingly, the failure to receive the notification data may indicate that the payment transaction is a failed payment transaction. In one such implementation, the user device 110 (e.g., via the wallet application 112) may make such a determination after a predetermined amount of time has elapsed since the initiation of the payment transaction.

In one example, the failure to receive the notification data may be indicative of one or more communication failures between the user device 110 and the merchant 120 (i.e., via the one or more computing systems 121), such as for a torn transaction. In such an example, the issuer 150 (i.e., via the one or more computing systems 151) may fail to receive the authorization request data and, in turn, may fail to provide authorization response data indicating that the payment transaction is approved. In another example, the failure to receive the notification data may be indicative of an offline decline decision by the merchant and/or the user device 110. As noted above, based on the offline decline decision by the merchant and/or the user device 110, the merchant 120 (i.e., via the one or more computing systems 121) may fail to transmit authorization request data to the acquirer 130 (i.e., via the one or more computing systems 131). Thus, in such an example, the issuer 150 (i.e., via the one or more computing systems 151) may fail to receive the authorization request data and, in turn, may fail to provide authorization response data indicating that the payment transaction is approved. In yet another example, the failure to receive the notification data may be indicative of one or more communication failures between the user device 110 and the TSP 140 (i.e., via the one or more computing systems 141). In such an example, the issuer 150 (i.e., via the one or more computing systems 151) may fail to receive the authorization request data and, in turn, may fail to provide authorization response data indicating that the payment transaction is approved.

However, in some examples, the failure to receive the notification data may merely be indicative of a transit transaction and/or that the user device 110 disallows such notifications, such that the failure to receive the notification data may not be indicative of a communication failure between the user device and the merchant 120. In such examples, the user device 110 may not determine that the payment transaction is a failed payment transaction based on the failure to receive notification data.

At 410A, based on the determination that the failed payment transaction has occurred, the user device 110 (e.g., via the wallet application 112) may generate transaction report data and then transmit the transaction report data to the wallet provider 160 (i.e., via the one or more computing systems 161). As noted above, the transaction report data may include data that corresponds to a transaction log of the failed payment transaction, a date and/or time of the failed payment transaction, a location of the failed payment transaction, or combinations thereof. In one implementation, the user device 110 may begin recording such data after determining that a payment transaction has been initiated. Those skilled in the art will understand that the transaction report data may include other forms of data, such that the transaction report data is not limited to the implementations described herein.

The transaction log may correspond to the command data and the response data exchanged between the user device 110 (e.g., via the wallet application 112) and the merchant 120 (i.e., via the one or more computing systems 121), as explained above. Data corresponding to the transaction log may hereinafter be referred to as transaction log data. In some implementations, the transaction log data may include data relating to fields DE55 as defined by EMV-based standards, protocols, and/or specifications, as is known in the art. The transaction log data may indicate one or more of the following instances: a torn transaction due to a failure to receive the generate AC command data from the merchant 120 and/or a failure to transmit response data (e.g., a response APDU) that includes an AC (e.g., an ARQC) to the merchant 120; a torn transaction due to a failure to receive the generate dynamic CVC command data from the merchant 120 and/or a failure to transmit response data that includes the dynamic CVC to the merchant; an offline decline decision by the merchant 120 based on receiving the generate AC command data that requires the AAC from the user device 110; an offline decline decision by the user device 110 based on transmitting a response APDU that includes the AAC; an offline decline decision and/or a failure relating to the offline data authentication, including CDA; an offline decline decision and/or a failure relating to multiple attempts to perform the same payment transaction; an offline decline decision and/or a failure related to incorrect cryptographic keys, digital certificates, PINs, or CVM data; an offline decline decision and/or a failure related to an expired digital token; and/or the like. Further, Payment Card Industry (PCI) data and/or Personally Identifiable Information (Pll)-related data within the transaction log may be encrypted, masked, and/or the like.

In addition, data corresponding to the data and/or time of the failed payment transaction may hereinafter be referred to as timestamp data. The user device 110 may determine the location data of the failed payment transaction using any technology known to those skilled in the art, including the use of a satellite navigation system (e.g., global positioning system (GPS)). In some implementations, the merchant 120 (i.e., via the one or more computing systems 121) may transmit the location data to the user device 110 during the exchange of the command data and the response data, as described above.

In some implementations, the user device 110 (e.g., via the wallet application 112) may generate and transmit the transaction report data on the condition that the user device 110 (e.g., via the wallet application 112) has received data indicating that the user 102 consents to providing the transaction report data to the TSP 140. Such data may hereinafter be referred to as consent data. If the user 102 fails to provide the consent data, then the user device 110 (e.g., via the wallet application 112) may not generate or transmit the transaction report data.

At 410B, the wallet provider 160 (i.e., via the one or more computing systems 161) may transmit the transaction report data to the one or more computing systems 141 of the TSP 140. In another implementation, at 412, the user device 110 (e.g., via the wallet application 112) may directly transmit the transaction report data to the one or more computing systems 141 of the TSP 140.

At 414, the TSP 140 (i.e., via the one or more computing systems 141) may generate failure data based on the transaction report data. As noted above, the failure data may include alert data and/or failure report data. In particular, the TSP 140 (i.e., via the one or more computing systems 141) may analyze the transaction report data and then, based on the analysis, generate the failure data (e.g., alert data and/or failure report data).

As explained above, the alert data may include data that corresponds to one or more alert notifications, such as alert notifications provided to one or more operators of the TSP 140. Examples of the one or more alert notifications may include one or more automated messages, push notifications, emails, and/or the like. In addition, the one or more alert notifications may indicate that a failed payment transaction has occurred and/or that a number of failed payment transactions associated with a particular element of the system 100 (e.g., the user device 110, the merchant 120, the wallet provider 160, the acquirer 130, the payment network 170, and/or the issuer 150) is greater than or equal to a predetermined threshold number, such as for a set period of time.

As is also explained above, the failure report data may include data that corresponds to one or more failed payment transactions of all transaction report data received by the TSP 140, such as for a set period of time. Further, the failure report data may include the entirety of, or a subset of, the transaction report data received by the TSP 140 for the set period of time. In one example, the TSP 140 (i.e., via the one or more computing systems 141) may generate the failure report data if a number of failed payment transactions associated with a particular element of the system 100 (e.g., the user device 110, the merchant 120, the wallet provider 160, the acquirer 130, the payment network 170, and/or the issuer 150) is greater than or equal to a predetermined threshold number, such as for a set period of time.

In response to the failure data (e.g., the alert data and/or the failure report data), the TSP 140 may identify one or more commonalities and/or patterns among the failed payment transactions, such that the TSP 140 may identify the one or more causes for the failed payment transactions. Further, after identifying the one or more causes, the TSP 140 may be able to perform one or more actions to rectify these causes and to avoid additional failed payment transaction processes. The one or more causes may include any type of cause known in the art, including, but not limited to, the following: one or more hardware malfunctions, one or more software malfunctions, and/or the like. In some implementations, the TSP 140 (i.e., via the one or more computing systems 141) may store the transaction report data in a transaction report database associated with the one or more computing systems 141. In other implementations, the one or more actions by the TSP 140 to rectify these causes may include notifying an entity associated with a particular element of the system 100 (e.g., the user device 110, the merchant 120, the wallet provider 160, the acquirer 130, the payment network 170, and/or the issuer 150) regarding the number of failed payment transactions that involve the element and/or the entity. In such implementations, the TSP 140 may provide data (e.g., the transaction report data or the failure report data) when notifying the entity. For example, the TSP 140 may transmit failure report data to the payment network 170 if the number of failed payment transactions involving merchant POS devices (e.g., the computing systems 121) managed by the payment network 170 is greater than or equal to a predetermined threshold number.

FIG. 5 illustrates a sequencing diagram 500 in accordance with implementations of various techniques described herein. In particular, the sequencing diagram 500 may represent another implementation of a process by the system 100, where the system 100 may be utilized to provide transaction report data corresponding to a failed payment transaction. While the sequencing diagram is discussed with respect to FIGS. 1-4, those skilled in the art will understand that implementations may not limited to the operation and/or system discussed below.

With respect to FIG. 5, the user 102 (i.e., via the user device 110) may initiate a payment transaction with the merchant 120 (i.e., via the one or more computing systems 121) in order to purchase one or more products from the merchant 120. As explained above, the user device 110 (including the wallet application 112) and the one or more computing systems 121 may be configured to process the payment transaction in accordance with any standards, protocols, and/or specifications known in the art (e.g., EMV-based standards, magnetic stripe-based standards, QR code-based standards, and/or the like).

At 502, to initiate the payment transaction with the merchant 120, the user 102 may provide selection input data to the user device 110. The selection input data may correspond to a selection of the wallet application 112 for use in performing the payment transaction using a digital token. The selection input data may be similar to the selection input data described above with respect to FIGS. 3 and 4. Further, the implementations of 502 may be similar to the implementations of 302 and 402 described above with respect to FIGS. 3 and 4.

At 504, to perform the payment transaction between the user 102 and the merchant 120, the user device 110 (e.g., via the wallet application 112) and the merchant 120 (i.e., via the one or more computing systems 121) may exchange command data and response data. The command data and the response data may be similar to the command data and the response data described above with respect to FIGS. 3 and 4. Further, the implementations of 504 may be similar to the implementations of 304 and 404 described above with respect to FIGS. 3 and 4.

At 506, the merchant 120 (i.e., via the one or more computing systems 121) may generate authorization request data and then transmit the authorization request data to the one or more computing systems 131 of the acquirer 130. The authorization request data may be similar to the authorization request data described above with respect to FIGS. 3 and 4. Further, the implementations of 506 may be similar to the implementations of 306 described above with respect to FIG. 3.

At 507, the acquirer 130, using its one or more computing systems 131, may transmit the authorization request data to the one or more computing systems 171 of the payment network 170. The implementations of 507 may be similar to the implementations of 307 described above with respect to FIG. 3. At 508, the payment network 170, using its one or more computing systems 171, may transmit the authorization request data to the one or more computing systems 141 of the TSP 140. The implementations of 508 may be similar to the implementations of 308 described above with respect to FIG. 3.

In one implementation, as discussed above, the TSP 140 (i.e., via the one or more computing systems 141) may retrieve the payment card data corresponding to the digital token of the received authorization request data. In such an implementation, the TSP 140 (i.e., via the one or more computing systems 141) may retrieve the payment card data using the database (i.e., the token vault) discussed with respect to FIG. 2. In particular, the TSP 140 (i.e., via the one or more computing systems 141) may use this database to map the digital token to its associated payment card data.

In another implementation, as discussed above, the TSP 140 (i.e., via the one or more computing systems 141) may, on behalf of the issuer 150, validate the response data received from the user device 110 and included in the authorization request data. The TSP 140 (i.e., via the one or more computing systems 141) may validate the response data using any technique known in the art. Upon a successful validation, the TSP 140 (i.e., via the one or more computing systems 141) may transmit the authorization request data to the one or more computing systems 151 of the issuer 150.

However, for an unsuccessful validation, the TSP 140 (i.e., via the one or more computing systems 141) may generate an online decline decision, such that the TSP 140 declines to transmit the authorization request data to the issuer 150, as is shown in FIG. 5. Thus, for the unsuccessful validation of FIG. 5, the issuer 150 (i.e., via the one or more computing systems 151) does not receive authorization request data and, consequently, fails to provide authorization response data indicating that the payment transaction is approved. Thus, the payment transaction of FIG. 5 is a failed payment transaction. The TSP 140 may generate the online decline decision for any reason known in the art. For example, the TSP 140 may determine that there are one or more errors with respect to the authorization request data received from the acquirer 130.

At 509, using its one or more computing systems 141, the TSP 140 may transmit authorization response data to the one or more computing systems 171 of the payment network 170, where the authorization response data indicates the online decline decision by the TSP 140 (i.e., via the one or more computing systems 141). At 511, the TSP 140 (i.e., via the one or more computing systems 141) may transmit advice data to the issuer 150 (i.e., via the one or more computing systems 151) based on the online decline decision.

At 510, the payment network 170, using its one or more computing systems 171, may transmit the authorization response data to the one or more computing systems 131 of the acquirer 130. At 512, the acquirer 130, using its one or more computing systems 131, may transmit the authorization response data to the one or more computing systems 121 of the merchant 120. At 514, the one or more computing systems 121 of the merchant 120 may display a message to the user 102, where the message indicates that the payment transaction is declined. In one implementation, the one or more computing systems 121 may use a presentation unit to display the message.

At 516, the user device 110 (e.g., via the wallet application 112) may determine whether a failed payment transaction has occurred. The implementations of 516 may be similar to the implementations of 408 described above with respect to FIG. 4. In particular, the user device 110 and/or the wallet application 112 may first determine whether a payment transaction between the user 102 and the merchant 120 had been initiated. Upon determining that the payment transaction between the user 102 and the merchant 120 had been initiated, the user device 110 and/or the wallet application 112 may then determine whether the payment transaction is a failed payment transaction.

In one implementation, as similarly described above with respect to FIG. 4, the user device 110 (e.g., via the wallet application 112) may determine that the payment transaction is a failed payment transaction based on a failure to receive notification data from the wallet provider 160, the TSP 140, and/or the issuer 150. In particular, the failure to receive the notification data at the user device 110 may indicate that the issuer 150 (i.e., via the one or more computing systems 151) failed to provide authorization response data indicating that the payment transaction is approved. Accordingly, the failure to receive the notification data may indicate that the payment transaction is a failed payment transaction.

For example, the failure to receive the notification data may be indicative of an online decline decision by the TSP 140, as shown in FIG. 5. As noted above, based on the online decline decision by the TSP 140, the TSP 140 (i.e., via the one or more computing systems 141) may fail to transmit the authorization request data to the issuer 150 (i.e., via the one or more computing systems 151). In another example, though not shown in FIG. 5, the failure to receive the notification data may be indicative of an online decline decision by the issuer 150. In such an example, the issuer 150 (i.e., via the one or more computing systems 151) may generate authorization response data that includes the online decline response from the issuer 150, such that the payment transaction is declined (i.e., the payment transaction is a failed payment transaction). The issuer 150 may decline the payment transaction based on the one or more financial assessments described above, a failed validation of the response data (e.g., the response APDU) received from the user device 110, and/or the like.

At 518A, based on the determination that the failed payment transaction has occurred, the user device 110 (e.g., via the wallet application 112) may generate transaction report data and then transmit the transaction report data to the wallet provider 160 (i.e., via the one or more computing systems 161). The transaction report data may be similar to the transaction report data described above with respect to FIG. 4. Further, the implementations of 518A may be similar to the implementations of 410A described above with respect to FIG. 4. At 518B, the wallet provider 160 (i.e., via the one or more computing systems 161) may transmit the transaction report data to the one or more computing systems 141 of the TSP 140.

In another implementation, at 520, the user device 110 (e.g., via the wallet application 112) may directly transmit the transaction report data to the one or more computing systems 141 of the TSP 140. At 522, the TSP 140 (i.e., via the one or more computing systems 141) may generate failure data based on the transaction report data. The failure data may be similar to the failure data described above with respect to FIG. 4. Further, the implementations of 522 may be similar to the implementations of 414 described above with respect to FIG. 4. In particular, the TSP 140 (i.e., via the one or more computing systems 141) may analyze the transaction report data and then, based on the analysis, generate the failure data (e.g., alert data and/or failure report data).

As similarly discussed above, in response to the failure data (e.g., the alert data and/or the failure report data), the TSP 140 may identify one or more commonalities and/or patterns among the failed payment transactions, such that the TSP 140 may identify the one or more causes for the failed payment transactions. Further, after identifying the one or more causes, the TSP 140 may be able to perform one or more actions to rectify these causes and to avoid additional failed payment transaction processes. The one or more causes may include any type of cause known in the art, including, but not limited to, the following: one or more hardware malfunctions, one or more software malfunctions, and/or the like. In some implementations, the TSP 140 (i.e., via the one or more computing systems 141) may store the transaction report data in a transaction report database associated with the one or more computing systems 141. In other implementations, the one or more actions by the TSP 140 to rectify these causes may include notifying an entity associated with a particular element of the system 100 (e.g., the user device 110, the merchant 120, the wallet provider 160, the acquirer 130, the payment network 170, and/or the issuer 150) regarding the number of failed payment transactions that involve the element.

As noted above, in some implementations (and as shown in FIGS. 1-5), the payment network 170 may be operated by and/or provided by an entity that is separate from and/or unrelated to other elements of the system 100, including the TSP 140. In such implementations, the payment network 170 and the TSP may communicate using any technique known in the art, including those discussed above (e.g., via APIs, via the one or more networks 105, and/or the like). As is also noted above, in other implementations, the payment network 170 and the TSP 140 may correspond to the same entity, such that the payment network 170 may also function as the TSP 140 for the system 100. In such implementations, the payment network 170 and the TSP 140 may communicate using any technique known in the art (e.g., transmitting messages through internal systems for logging, monitoring and resolution).

Those skilled in the art will understand that implementations of the system 100 may perform more, fewer, or different operations than those described above. Further, although operations above are discussed with respect to one arrangement of the system 100, those skilled in the art will understand that operation may be performed for other arrangements of the system 100 and/or with additional elements. For example, though one merchant 120 is shown in FIG. 1, those skilled in the art will understand that the implementations described herein may be applied to a plurality of merchants 120. In another example, though one user 102 is shown in FIG. 1, those skilled in the art will understand that the implementations described herein may be applied to a plurality of users 102. In addition, though the above-described implementations utilized a digital token, those skilled in the art will understand that the implementations may be applied to other data, including payment card data.

Accordingly, in view of the implementations discussed above with respect to FIGS. 1-5, various implementations of a system and method for providing transaction report data using a user device are described herein. In some implementations, after a failed payment transaction has been performed using a user device and a merchant system, the user device may generate transaction report data that corresponds to the failed payment transaction. The transaction report data may include data that corresponds to a transaction log of the failed payment transaction, a date and/or time of the failed payment transaction, a location of the failed payment transaction, or combinations thereof. The user device may then transmit the transaction report data to a TSP. In response, the TSP may analyze the transaction report data. In some implementations, the TSP may generate failure data based on the transaction report data, where the failure data may include alert data and/or failure report data.

In particular, by using the implementations disclosed herein, a TSP may analyze the transaction report data for all user devices, merchants, wallet providers, acquirers, payment networks, and/or issuers associated with its system for a set period of time. Based on the analysis of this transaction report data, the TSP may identify one or more commonalities and/or patterns among the failed payment transactions, such that the TSP may identify the one or more causes for the failed payment transactions. Further, after identifying the one or more causes, the TSP may be able to perform one or more actions to rectify these causes and to avoid additional failed payment transaction processes.

Furthermore, the use of the transaction report data may be of use for certain scenarios in which the TSP and/or other entities may be unaware of the failed payment transaction processes performed by the user devices and the merchant systems. In such scenarios, the TSP may be unable to analyze the failed payment transaction processes, and, in turn, the TSP may be unable to identify one or more causes related to the failed payment transaction processes. By using the implementations disclosed herein, a TSP may analyze the transaction report data to proactively identify such causes. By identifying such causes, the TSP may be able to minimize the number of failed payment transaction processes experienced by users and merchants.

### III. Computing System

FIG. 6 illustrates a diagram of a computing system 600 in which one or more various technologies described herein may be incorporated and practiced. The computing system 600 may be any computing system known to those skilled in the art. For example, the computing system 600 may include one or more servers, workstations, personal computers, laptops, tablets, smartphones, personal digital assistants (PDAs), and/or the like. In one implementation, the computing system 600 may include a single computing system. In another implementation, the computing system 600 may include multiple computing systems located in close proximity and/or distributed over a geographic region, where the computing systems may be configured to function as described herein.

The computing system 600 can be used to implement one or more of the computing systems discussed above, such as the devices and systems 110, 121, 131, 141, 151, and 161. Those skilled in the art will understand that the system 100 may use different computing systems and/or arrangements of computing systems than those described with respect to FIG. 6. In addition, different components and/or arrangements of components may be used in other computing systems.

Referring to FIG. 6, the computing system 600 may include a processor 602 and a memory 604 coupled to and/or in communication with the processor 602. The processor 602 may include one or more processing units (e.g., in a multi-core configuration and/or the like). For example, the processor 602 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 604, as described herein, may include one or more devices that permit data, instructions, etc., to be stored therein and retrieved therefrom. The memory 604 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 604 may be configured to store, without limitation, images, private and/or public keys, public/private key pairs, identity records, certified and/or certification records, hashed data, signed data, one or more data structures, and/or other types of data suitable for use as described herein. Furthermore, in various implementations, computer-executable instructions may be stored in the memory 604 for execution by the processor 602 to cause the processor 602 to perform one or more of the functions described herein, such that the memory 604 may be a physical, tangible, and non-transitory computer readable storage media. Such instructions may be used to improve the efficiencies and/or performance of the processor 602 and/or other computer system components configured to perform one or more of the various operations herein. It should be appreciated that the memory 604 may include a variety of different memories, each implemented in one or more of the functions or processes described herein.

The computing system 600 may also include a presentation unit 606 that is coupled to and/or in communication with the processor 602. However, it should be appreciated that the computing system 600 could include output devices other than the presentation unit 606 and/or the like. The presentation unit 606 may output information to a user, such as by using a visual output. Further, one or more interfaces may be displayed at computing system 600, including at presentation unit 606, to display certain information. The one or more interfaces may be defined by the one or more applications mentioned above, defined by websites, defined by mobile applications, and/or the like. In addition, the one or more interfaces may be used to capture images of documents, capture selfies, capture biometrics, and/or the like. The presentation unit 606 may include, without limitation, a liquid crystal display (LCD), a light-emitting diode (LED) display, an organic LED (OLED) display, an “electronic ink” display, speakers, and/or the like. In some implementations, the presentation unit 606 may include multiple devices.

In addition, the computing system 600 may include an input device 608 configured to receive and/or acquire one or more inputs from a user (i.e., user inputs), such as in response to prompts from the one or more applications described above. The one or more inputs may include images of documents, images of a user (e.g., biometric data), and/or the like. The input device 608 may include a single input device or multiple input devices. The input device 608 may be coupled to and/or in communication with the processor 602. The input device 608 may include, for example, a keyboard, a pointing device, a mouse, a stylus, a camera, fingerprint scanner, a touch sensitive panel (e.g., a touch pad, a touch screen, and/or the like), acquisition equipment as described above, another computing system, an audio input device, or combinations thereof. In one implementation, a touch screen, such as that included in a tablet, a smartphone, or similar device, may behave as both a presentation unit and an input device. As mentioned above, the computing system may include and/or configured to be coupled to any equipment used to acquire one or more images of documents and/or biometric data. Such equipment may include a camera, a biometric sensor (e.g., fingerprint sensor, iris scanner, palm scanner, and/or the like), and/or any other device configured to acquire such data.

Further, the illustrated computing system 600 may include a network interface 610 coupled to and/or in communication with the processor 602 and the memory 604. The network interface 610 may include, without limitation, a wired network adapter, a wireless network adapter (e.g., a near field communication (NFC) adapter, a Bluetooth adapter, and/or the like), a mobile network adapter, and/or other devices capable of communicating to one or more different devices of the networks described herein. Further, in some implementations, the computing system 600 may include the processor 602 and one or more network interfaces incorporated into or with the processor 602. In some implementations, the computing system 600 may include global positioning system (GPS) capability, whereby the computing system 600 may determine its current geographic location, perform mapping applications, and/or the like.

The description provided herein may be directed to specific implementations. It should be understood that the discussion provided herein is provided for the purpose of enabling a person with ordinary skill in the art to make and use any subject matter defined herein by the subject matter of the claims.

It should be intended that the subject matter of the claims not be limited to the implementations and illustrations provided herein, but include modified forms of those implementations including portions of implementations and combinations of elements of different implementations in accordance with the claims. It should be appreciated that in the development of any such implementation, as in any engineering or design project, numerous implementation-specific decisions should be made to achieve a developers’ specific goals, such as compliance with system-related and business related constraints, which may vary from one implementation to another. Moreover, it should be appreciated that such a development effort may be complex and time consuming, but would nevertheless be a routine undertaking of design, fabrication, and manufacture for those of ordinary skill having benefit of this disclosure.

Reference has been made in detail to various implementations, examples of which are illustrated in the accompanying drawings and figures. In the detailed description, numerous specific details are set forth to provide a thorough understanding of the disclosure provided herein. However, the disclosure provided herein may be practiced without these specific details. In some other instances, well-known methods, procedures, components, circuits, and networks have not been described in detail so as not to unnecessarily obscure details of the embodiments.

It should also be understood that, although the terms first, second, etc. may be used herein to describe various elements, these elements should not be limited by these terms. These terms are only used to distinguish one element from another. For example, a first element could be termed a second element, and, similarly, a second element could be termed a first element. The first element and the second element are both elements, respectively, but they are not to be considered the same element.

The terminology used in the description of the disclosure provided herein is for the purpose of describing particular implementations and is not intended to limit the disclosure provided herein. As used in the description of the disclosure provided herein and appended claims, the singular forms “a,” “an,” and “the” are intended to include the plural forms as well, unless the context clearly indicates otherwise. The term “and/or” as used herein refers to and encompasses any and all possible combinations of one or more of the associated listed items. The terms “includes,” “including,” “comprises,” and/or “comprising,” when used in this specification, specify a presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. The terms “up” and “down”; “upper” and “lower”; “upwardly” and “downwardly”; “below” and “above”; and other similar terms indicating relative positions above or below a given point or element may be used in connection with some implementations of various technologies described herein.

While the foregoing is directed to implementations of various techniques described herein, other and further implementations may be devised in accordance with the disclosure herein, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, comprising:
receiving, at a token service provider (TSP), tokenization request data from a user device associated with a user, wherein the tokenization request data comprises payment card data associated with the user;
generating, at the TSP, a digital token based on the tokenization request data;
transmitting, using the TSP, the digital token to the user device;
receiving, at the TSP, transaction report data from the user device, wherein the transaction report data corresponds to a failed payment transaction performed using the digital token, the user device, and a merchant system; and
generating, at the TSP, failure data based on the transaction report data, wherein the failure data comprises alert data, failure report data, or combinations thereof.

2. The method of claim 1, wherein the payment card data comprises data corresponding to a primary account number for a payment account of the user, wherein payment account comprises a banking account, a checking account, a savings account, a credit card account, a debit card account, a prepaid card account, or a virtual payment account.

3. The method of claim 1, wherein receiving, at the TSP, the transaction report data comprises receiving, at the TSP, the transaction report data from a wallet system associated with a wallet application of the user device, wherein the wallet system is configured to receive the transaction report data from the user device.

4. The method of claim 1, wherein:
the TSP comprises a payment network;
the failed payment transaction comprises a Quick Response (QR) code-based payment transaction;
the user device is configured to transmit the transaction report data based on consent data received from the user;
the merchant system comprises a merchant server or a merchant point-of-sale (POS) device; or
combinations thereof.

5. The method of claim 1, wherein the transaction report data comprises:
transaction log data corresponding to the failed payment transaction, wherein the transaction log data comprises command data transmitted by the merchant system and response data transmitted by the user device;
timestamp data corresponding to the failed payment transaction, wherein the timestamp data comprises data corresponding to a date, time, or both with respect to the failed payment transaction;
location data corresponding to the failed payment transaction; or
combinations thereof.

6. The method of claim 1, wherein the user device is configured to:
perform the failed payment transaction with the merchant system using a wallet application stored on the user device;
perform the failed payment transaction with the merchant system using contactless communication; or
combinations thereof.

7. The method of claim 1, wherein the failed payment transaction corresponds to a payment transaction for which an issuer associated with the payment account does not generate authorization response data indicating that the payment transaction is approved.

8. The method of claim 1, wherein the user device is configured to generate the transaction report data for the failed payment transaction based on a determination that the user device failed to receive command data from the merchant system for generating an application cryptogram (AC), transmit an AC to the merchant system, or combinations thereof.

9. The method of claim 1, wherein the user device is configured to generate the transaction report data for the failed payment transaction based on a determination that the user device failed to receive command data from the merchant system for generating a dynamic Card Validation Code (CVC), transmit response data that includes the dynamic CVC, or combinations thereof.

10. The method of claim 1, wherein the user device is configured to generate the transaction report data for the failed payment transaction based on a determination that command data transmitted by the merchant system or response data transmitted by the user device are indicative of an offline decline decision by the user device, by the merchant system, or combinations thereof.

11. The method of claim 1, wherein the user device is configured to generate the transaction report data for the failed payment transaction based on a determination that the user device failed to receive notification data from the TSP, an issuer associated with the payment account, or combinations thereof.

12. The method of claim 11, wherein the failed payment transaction is indicative of a torn transaction, an offline decline decision by the user device or the merchant system, a communication failure between the merchant system and the TSP, or an online decline decision by the TSP or an issuer associated with the payment account.

13. The method of claim 1, wherein generating, at the TSP, the failure data comprises generating the alert data based on one or more first predetermined threshold numbers, generating the failure report data based on one or more second predetermined threshold numbers, or combinations thereof.

14. A method, comprising:
receiving, at a user device associated with a user, a digital token from a token service provider (TSP), wherein the digital token corresponds to payment card data associated with the user;
determining a failed payment transaction has occurred, wherein the failed payment transaction is performed using the digital token, the user device, and a merchant system; and
generating, at the user device, transaction report data based on the determination; and
transmitting, using the user device, the transaction report data to the TSP.

15. The method of claim 14, wherein determining the failed payment transaction has occurred comprises:
determining that the user device failed to receive command data from the merchant system for generating an application cryptogram (AC), transmit an AC to the merchant system, or combinations thereof; or
determining that the user device failed to receive command data from the merchant system for generating a dynamic Card Validation Code (CVC), transmit response data that includes the dynamic CVC, or combinations thereof.

16. The method of claim 14, wherein determining the failed payment transaction has occurred comprises: determining that command data transmitted by the merchant system or response data transmitted by the user device are indicative of an offline decline decision by the user device, by the merchant system, or combinations thereof.

17. The method of claim 14, wherein determining the failed payment transaction has occurred comprises determining that the user device failed to receive notification data from the TSP, an issuer associated with the payment account, or combinations thereof.

18. The method of claim 17, wherein the failed payment transaction is indicative of a torn transaction, an offline decline decision by the user device or the merchant system, a communication failure between the merchant system and the TSP, or an online decline decision by the TSP or an issuer associated with the payment account.

19. A system, comprising:
a user device associated with a user, comprising:
one or more first processors; and
at least a first memory comprising a plurality of program instructions which, when executed by the one or more first processors, cause the one or more first processors to:
receive a digital token from a token service provider (TSP), wherein the digital token corresponds to payment card data associated with the user;
determine a failed payment transaction has occurred, wherein the failed payment transaction is performed using the digital token, the user device, and a merchant system; and
generate transaction report data based on the determination; and
transmit the transaction report data to the TSP; and
the TSP, comprising:
one or more second processors; and
at least a second memory comprising a plurality of program instructions which, when executed by the one or more second processors, cause the one or more second processors to:
generate the digital token based on the payment card data;
transmit the digital token to the user device;
receive the transaction report data from the user device; and
generate failure data based on the transaction report data, wherein the failure data comprises alert data, failure report data, or combinations thereof.

20. The system of claim 19, wherein the transaction report data comprises:
transaction log data corresponding to the failed payment transaction, wherein the transaction log data comprises command data transmitted by the merchant system and response data transmitted by the user device;
timestamp data corresponding to the failed payment transaction, wherein the timestamp data comprises data corresponding to a date, time, or both with respect to the failed payment transaction;
location data corresponding to the failed payment transaction; or
combinations thereof.
